(19) United States
(12) Patent Application Publication
(10) Pub. No.: US 2026/0329037 A1
(43) Pub. Date: Oct. 22, 2026

(54) OPTICAL COUPLER-ENABLED WAFER RECONSTITUTION FOR PHOTONIC INTEGRATED CIRCUITS

(71) Applicant: Lightmatter, Inc., Mountain View, CA (US)

(72) Inventors: Sufi Ahmed, Chandler, AZ (US); Shashank Gupta, Gurugram (IN); Omkar Karhade, Chandler, AZ (US)

(73) Assignee: Lightmatter, Inc., Mountain View, CA (US)

(21) Appl. No.: 19/652,564

(22) Filed: Apr. 20, 2026

Related U.S. Application Data
(60) Provisional application No. 63/792,204, filed on Apr. 21, 2025.

(51) Int. Cl. G02B 6/43; G02B 6/42

(52) U.S. Cl. CPC G02B 6/43; G02B 6/4212; G02B 6/4214; G02B 6/4239

(57) ABSTRACT

Traditional reticle stitching for photonic integrated circuits (PIC) limits PIC size to what can be achieved with adjacent good dies on a single wafer. With wafer yields below 100%, finding enough contiguous good reticles for large PICs becomes increasingly difficult and expensive. The techniques described herein reconstitute good tiles from one or more source wafers onto a carrier, decoupling the physical adjacency requirement from yield constraints. A challenge in wafer reconstitution is ensuring optical alignment between reconstituted tiles. Optical couplers are mounted on the tiles to achieve self-alignment upon reconstitution. The couplers include reflectors that steer light outside the waveguide plane and expand the mode field diameter, increasing alignment tolerance. Index matching epoxy disposed between adjacent couplers reduces reflections. Optionally, optical bridges positioned above or below the couplers further improve coupling efficiency between adjacent tiles.

### CROSS-REFERENCE TO RELATED APPLICATIONS

This application claims the benefit of U.S. Provisional Application Ser. No. 63/792,204, filed on Apr. 21, 2025, under Attorney Docket No. L0858.70126US00 and entitled “OPTICAL STITCHING OF MULTIPLE RETICLES,” which is hereby incorporated herein by reference in its entirety.

### BACKGROUND

Photonic integrated circuits (PICs) have emerged as a key technology for advancing the performance of modern computing and communication systems. By leveraging the high-speed and low-loss properties of light, PICs enable the transmission and processing of data at significantly higher bandwidths and lower latencies compared to conventional electronic interconnects. In addition, PICs support scalable architectures by facilitating parallel optical links that can be integrated alongside electronic circuitry. As a result, PICs are increasingly being adopted in data centers, artificial intelligence accelerators, high-performance computing, and other bandwidth-intensive applications.

The growing demand for high-bandwidth interconnects in data centers has accelerated the development and deployment of photonic technologies. Data centers process vast amounts of information and require efficient communication between servers, storage systems, and networking equipment. Optical interconnects offer advantages in terms of signal integrity over longer distances and reduced power consumption compared to electrical interconnects, making them attractive for data center architectures.

Some PICs are manufactured using complementary metal-oxide-semiconductor (CMOS) compatible processes. CMOS-compatible fabrication leverages existing semiconductor manufacturing infrastructure, which may decrease production costs and enable scaled production of photonic devices. The ability to utilize established foundry processes and equipment provides a pathway for high-volume manufacturing of PICs. Additionally, CMOS compatibility may facilitate the integration of photonic and electronic components on a common platform, supporting the development of heterogeneous systems that combine optical and electrical functionality.

### SUMMARY

In some aspects, the techniques described herein relate to a photonic device, including: a substrate; a first photonic tile, mounted on the substrate, including a first waveguide; a second photonic tile, mounted on the substrate, including a second waveguide; and a first optical coupler mounted on the first photonic tile and a second optical coupler mounted on the second photonic tile, wherein the first optical coupler is optically coupled to the first waveguide and the second optical coupler is optically coupled to the second waveguide, and wherein the first optical coupler is optically coupled to the second optical coupler.

In some aspects, the techniques described herein relate to a photonic device, wherein the first optical coupler includes a reflector configured to steer light outside a plane of the first waveguide.

In some aspects, the techniques described herein relate to a photonic device, wherein the first optical coupler is disposed in a recess formed in the first photonic tile.

In some aspects, the techniques described herein relate to a photonic device, further including an index matching epoxy disposed between the first optical coupler and the second optical coupler.

In some aspects, the techniques described herein relate to a photonic device, wherein the first optical coupler includes a curved reflector configured to expand a mode field diameter of light propagating from the first waveguide.

In some aspects, the techniques described herein relate to a photonic device, further including an optical bridge optically coupling the first optical coupler to the second optical coupler.

In some aspects, the techniques described herein relate to a photonic device, wherein the optical bridge is disposed on top of the first optical coupler and the second optical coupler, and wherein the optical bridge includes a reflector.

In some aspects, the techniques described herein relate to a photonic device, wherein the optical bridge is disposed in a recess formed in the substrate.

In some aspects, the techniques described herein relate to a photonic device, wherein the optical bridge is between the recess formed in the substrate and the first optical coupler.

In some aspects, the techniques described herein relate to a photonic device, wherein the first photonic tile and the second photonic tile include identical photonic patterns formed from a common photomask set.

In some aspects, the techniques described herein relate to a method of manufacturing a photonic device, the method including: mounting a first optical coupler on a first photonic tile obtained from a first wafer, the first photonic tile including a first waveguide; mounting a second optical coupler on a second photonic tile obtained from a second wafer, the second photonic tile including a second waveguide; mounting the first photonic tile, with the first optical coupler mounted thereon, on a carrier; and mounting the second photonic tile, with the second optical coupler mounted thereon, on the carrier such that the first optical coupler is optically coupled to the second optical coupler.

In some aspects, the techniques described herein relate to a method, wherein the first optical coupler includes a reflector configured to steer light outside a plane of the first waveguide.

In some aspects, the techniques described herein relate to a method, wherein mounting the first optical coupler on the first photonic tile includes disposing the first optical coupler in a recess formed in the first photonic tile.

In some aspects, the techniques described herein relate to a method, further including dispensing an index matching epoxy between the first optical coupler and the second optical coupler.

In some aspects, the techniques described herein relate to a method, further including: testing the first photonic tile prior to mounting the first photonic tile on the carrier; and selecting the first photonic tile for mounting on the carrier based on the testing.

In some aspects, the techniques described herein relate to a method, further including mounting an optical bridge spanning the first optical coupler and the second optical coupler.

In some aspects, the techniques described herein relate to a method of manufacturing a photonic device, the method including: obtaining a first wafer having a first plurality of photonic tiles; mounting a first plurality of optical couplers on respective tiles of the first plurality of photonic tiles; testing the first wafer to identify a first set of good dies from the first plurality of photonic tiles; obtaining a second wafer having a second plurality of photonic tiles; mounting a second plurality of optical couplers on respective tiles of the second plurality of photonic tiles; testing the second wafer to identify a second set of good dies from the second plurality of photonic tiles; and mounting at least some of the good dies of the first set and at least some of the good dies of the second set on a substrate such that at least one optical coupler of the first plurality is optically coupled to at least one optical coupler of the second plurality.

In some aspects, the techniques described herein relate to a method, wherein at least one optical coupler of the first plurality includes a reflector configured to steer light outside a plane of a waveguide of a respective tile of the first plurality of photonic tiles.

In some aspects, the techniques described herein relate to a method, further including dispensing an index matching epoxy between the at least one optical coupler of the first plurality and the at least one optical coupler of the second plurality.

In some aspects, the techniques described herein relate to a method, further including embedding an optical bridge in a recess formed in the substrate prior to mounting the good dies on the substrate, wherein the optical bridge is optically coupled to the at least one optical coupler of the first plurality and the at least one optical coupler of the second plurality.

### BRIEF DESCRIPTION OF FIGURES

Non-limiting and non-exhaustive examples are described with reference to the following figures.

FIG. 1 depicts a top-down view of a wafer containing an array of tiles, according to aspects of the present disclosure.

FIG. 2 depicts a wafer reconstitution process for forming a photonic integrated circuit using tiles from multiple source wafers, according to aspects of the present disclosure.

FIG. 3 depicts a cross-sectional view of a reconstituted photonic integrated circuit assembly with optical couplers between adjacent tiles, according to aspects of the present disclosure.

FIG. 4 depicts a cross-sectional view of an optical coupling arrangement between two adjacent tiles, according to aspects of the present disclosure.

FIGS. 5A-5V illustrate steps for manufacturing a photonic package with reconstituted tiles, according to aspects of the present disclosure. In the process step corresponding to FIG. 5A, a wafer patterned with tiles is obtained. In the process step corresponding to FIG. 5B, optical couplers are mounted on the tiles. In the process step corresponding to FIG. 5C, index matching epoxy is dispensed between adjacent optical couplers. In the process step corresponding to FIG. 5D, the wafer is mounted on a carrier. In the process step corresponding to FIG. 5E, a passivation layer is applied following wafer thinning. In the process step corresponding to FIG. 5F, a redistribution layer and bumps are formed. In the process step corresponding to FIG. 5G, electrical and optical probes test the tiles. In the process step corresponding to FIG. 5H, dies are mounted on passing tiles and dummy dies on failing tiles. In the process step corresponding to FIG. 5I, underfill is dispensed between the dies and the underlying structure. In the process step corresponding to FIG. 5J, a carrier is positioned above the assembly. In the process step corresponding to FIG. 5K, the carrier is removed. In the process step corresponding to FIG. 5L, a dicing operation separates individual die assemblies. In the process step corresponding to FIG. 5M, tile assemblies are mounted on a carrier for reconstruction. In the process step corresponding to FIG. 5N, index matching epoxy is dispensed between adjacent tile assemblies. In the process step corresponding to FIG. 5O, molding material is disposed around the die assemblies. In the process step corresponding to FIG. 5P, the molded assembly is planarized. In the process step corresponding to FIG. 5Q, the reconstituted wafer assembly is shown prior to substrate attachment. In the process step corresponding to FIG. 5R, the assembly is attached to a substrate. In the process step corresponding to FIG. 5S, underfill is disposed between the dies and the substrate. In the process step corresponding to FIG. 5T, thermal interface material is applied. In the process step corresponding to FIG. 5U, an integrated heat spreader with a window is attached. In the process step corresponding to FIG. 5V, a fiber is attached for external optical connectivity.

FIGS. 6A-6B depict a wafer reconstitution process for forming a photonic device with embedded optical bridges, according to aspects of the present disclosure. FIG. 6A depicts the extraction and transfer of tiles to a carrier. FIG. 6B depicts a cross-sectional view of an optical bridge spanning adjacent tiles.

FIG. 7A depicts a cross-sectional view of a photonic package assembly with an optical bridge positioned on top of optical couplers, according to aspects of the present disclosure.

FIG. 7B depicts a detailed cross-sectional view of an optical coupling arrangement with an optical bridge, according to aspects of the present disclosure.

FIG. 8 depicts a cross-sectional view of a photonic package assembly with an optical bridge embedded in a substrate, according to aspects of the present disclosure.

FIG. 9 depicts a detailed cross-sectional view of an optical coupling arrangement with an optical bridge positioned below optical couplers, according to aspects of the present disclosure.

FIGS. 10A-10W illustrate steps for manufacturing a photonic package with optical bridges, according to aspects of the present disclosure. In the process step corresponding to FIG. 10A, a wafer patterned with tiles is obtained. In the process step corresponding to FIG. 10B, optical couplers are attached to the tiles. In the process step corresponding to FIG. 10C, index matching epoxy is dispensed between adjacent optical couplers. In the process step corresponding to FIG. 10D, the tiles are supported on a carrier. In the process step corresponding to FIG. 10E, a passivation layer is deposited. In the process step corresponding to FIG. 10F, a redistribution layer and bumps are formed. In the process step corresponding to FIG. 10G, a carrier is positioned above the assembly. In the process step corresponding to FIG. 10H, the carrier is removed. In the process step corresponding to FIG. 10I, a dicing operation is performed. In the process step corresponding to FIG. 10J, electrical and optical probes test the tiles. In the process step corresponding to FIG. 10K, dies are mounted on passing tiles and dummy dies on failing tiles. In the process step corresponding to FIG. 10L, underfill is applied. In the process step corresponding to FIG. 10M, tile assemblies are mounted on a carrier for reconstruction. In the process step corresponding to FIG. 10N, index matching epoxy is dispensed between adjacent tile assemblies. In the process step corresponding to FIG. 10O, an optical bridge and beam collimators are attached. In the process step corresponding to FIG. 10P, molding material is applied. In the process step corresponding to FIG. 10Q, the molded assembly is shown on the carrier. In the process step corresponding to FIG. 10R, the assembly is shown prior to substrate attachment. In the process step corresponding to FIG. 10S, the die complexes are mounted onto a substrate. In the process step corresponding to FIG. 10T, underfill is applied. In the process step corresponding to FIG. 10U, thermal interface material is disposed on the die complexes. In the process step corresponding to FIG. 10V, an integrated heat spreader with a window is attached. In the process step corresponding to FIG. 10W, a fiber is attached for external optical connectivity.

FIGS. 11A-11Z-3 illustrate steps for manufacturing a photonic package with an optical bridge embedded in a substrate, according to aspects of the present disclosure. In the process step corresponding to FIG. 11A, a wafer patterned with tiles is obtained. In the process step corresponding to FIG. 11B, optical couplers are attached to the tiles. In the process step corresponding to FIG. 11C, index matching epoxy is dispensed between adjacent optical couplers. In the process step corresponding to FIG. 11D, a carrier is attached. In the process step corresponding to FIG. 11E, tiles are mounted on a carrier with through-silicon vias. In the process step corresponding to FIG. 11F, a passivation layer is deposited. In the process step corresponding to FIG. 11G, a redistribution layer and bumps are formed. In the process step corresponding to FIG. 11H, a dicing operation is performed. In the process step corresponding to FIG. 11I, tiles are positioned between two carriers. In the process step corresponding to FIG. 11J, the assembly is shown with a carrier at the bottom. In the process step corresponding to FIG. 11K, electrical and optical probes test the tiles. In the process step corresponding to FIG. 11L, tiles are positioned on a carrier for reconstruction. In the process step corresponding to FIG. 11M, index matching epoxy is dispensed between adjacent tiles. In the process step corresponding to FIG. 11N, a carrier is positioned at the top of the assembly. In the process step corresponding to FIG. 11O, the assembly is inverted and a carrier is removed. In the process step corresponding to FIG. 11P, dies are attached. In the process step corresponding to FIG. 11Q, underfill is applied. In the process step corresponding to FIG. 11R, molding material encapsulates the assembly. In the process step corresponding to FIG. 11S, dies are positioned on a carrier. In the process step corresponding to FIG. 11T, the assembly is shown in an inverted orientation with a carrier removed. In the process step corresponding to FIG. 11U, a substrate with a recess is provided. In the process step corresponding to FIG. 11V, an optical bridge is placed within the recess. In the process step corresponding to FIG. 11W, index matching epoxy is dispensed over the optical bridge. In the process step corresponding to FIG. 11X, dies are positioned on the substrate with the optical bridge. In the process step corresponding to FIG. 11Y, underfill is applied. In the process step corresponding to FIG. 11Z-1, thermal interface material is applied. In the process step corresponding to FIG. 11Z-2, an integrated heat spreader with a window is attached. In the process step corresponding to FIG. 11Z-3, a fiber is connected for external optical connectivity.

### DETAILED DESCRIPTION

Photonic integrated circuits (PICs) are sometimes fabricated by stitching multiple reticles (also referred to herein as “tiles” or “photonic modules”) to one another. Each tile may represent the instantiation of a reticle shot. Most photolithography systems have a maximum reticle field size (e.g., 26 mm×33 mm for deep ultra violet lithography). However, it may be desirable to design a PIC to exceed this size to increase the aggregate bandwidth beyond what is practical with one reticle. To overcome this limitation, reticle stitching may be used to tile together multiple exposure fields on the wafer, similar to puzzle pieces. These sections may be separately exposed on the wafer using precise stage movement and alignment. The stitch boundaries (the borders between exposures) may be tightly aligned, often within nanometer tolerances, to ensure optical continuity between waveguides of adjacent tiles.

The inventors have recognized and appreciated that traditional optical reticle stitching techniques for fabricating PICs present limitations. The manufacturing yield of an array of stitched dies may be limited by the availability of good (e.g., defect-free or with an acceptable amount of defects) adjacent tiles. For example, even with a 90% wafer yield, no more than a handful of good blocks of reticles may be available on a single wafer. This may make reticle stitching of large PICs increasingly expensive.

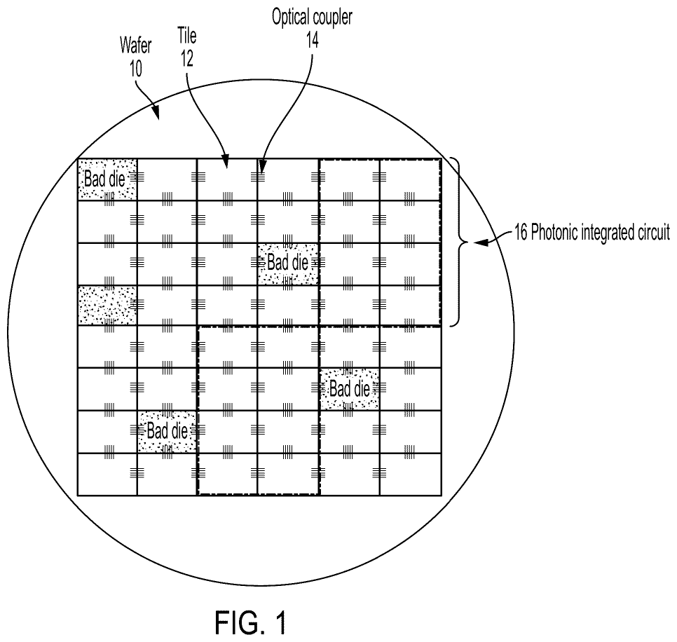

Referring to FIG. 1, a wafer 10 contains an array of tiles 12, where some tiles are marked as “bad dies” to indicate that they have failed a test. A photonic integrated circuit 16 is shown encompassing a group of tiles 12, illustrating how multiple tiles may be combined to form a larger PIC. Optical couplers 14 are positioned at the edges of each tile 12 to enable optical coupling between adjacent tiles.

The yield of each wafer may be less than 100%, meaning that on any given wafer, there may be only so many adjacent circuits that can be extracted. If a PIC including a 3×3 array of reticles is needed, there may be only so many good reticles that will allow that configuration. This may limit the number of such PICs that can be extracted from any given wafer.

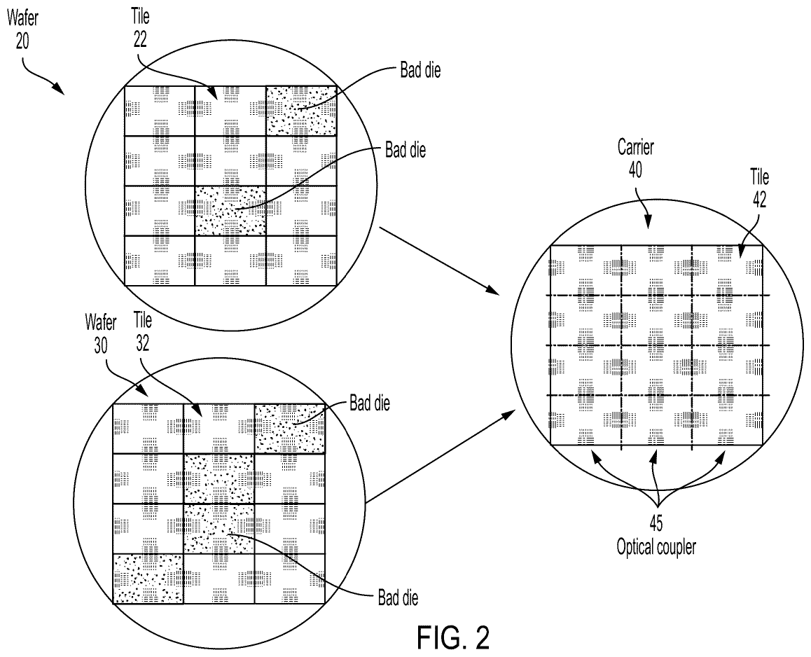

The approach developed by the inventors and described herein takes good dies from one or more wafers and repositions them on a carrier to reconstitute a circuit using building blocks (tiles), each tile corresponding to a reticle. Referring to FIG. 2, this reconstitution process is illustrated, where good tiles (e.g., tile 22 from wafer 20 and tile 32 from wafer 30) are extracted and transferred to carrier 40, forming reconstituted tiles 42 with optical couplers 45 disposed between adjacent tiles.

A challenge in wafer reconstitution is ensuring that the tiles, once reconstituted, are properly optically aligned to each other. The present disclosure addresses this issue by equipping each reticle with optical couplers and/or optical bridges. The optical couplers and bridges may be designed to achieve self-alignment with each other when a wafer is reconstituted.

In some embodiments, reticle-to-reticle optical stitching may be achieved through free space optics. In this scheme, optical couplers may be attached within a recess of a good PIC, which may expand the mode field diameter (MFD) and collimate the beam. The known good PICs may then be reconstructed on a carrier. Upon reconstruction, optical stitching between the adjacent reticles may occur through large MFD, collimated beam through free space coupling. The large MFD may increase the coupling efficiency and alignment tolerance. This approach may not only reduce the cost of optical stitching, but may also eliminate the limitation of reticle array available for optical stitching.

Optionally, optical bridges may be further used between optical couplers to facilitate reticle-to-reticle optical coupling. In this scheme, optical couplers may be attached in the recess of a good PIC, which may expand the mode field diameter (MFD) and project the beam towards the optical bridge. The known good PICs may be tested and reconstructed on a carrier. An optical bridge may be placed on top of or beneath the two adjacent dies. Both the optical couplers and bridge may have alignment fiducials or matching passive alignment features. The large MFD may also increase the alignment tolerance during coupler-to-bridge attach. An optical bridge may collimate the incoming large MFD beam from the optical coupler of the transmitting die and reflect it towards the optical coupler of the adjacent die. The optical coupler of the receiving die may collimate the beam and direct it toward the waveguide of the PIC, enabling die-to-die communication.

The techniques described herein may provide several benefits. First, they may eliminate the limitation of reticle array size available for optical stitching. Second, they may allow for the use of all good dies, regardless of whether adjacent dies are also good. As a result, the cost of optical stitching may be reduced significantly. In conventional reticle stitching approaches, the yield of a multi-reticle PIC may be constrained by the requirement that all constituent reticles be both functional and physically adjacent on the source wafer. For example, if a PIC design requires a 3×3 array of reticles, all nine reticles must be contiguous and defect-free on the same wafer. Given typical wafer yields of 70% to 90%, the probability of finding such a contiguous block of good reticles may be low, and may decrease exponentially as the desired array size increases. This constraint may result in substantial waste of otherwise functional reticles that happen to be adjacent to defective ones. By contrast, the reconstitution-based approach described herein may decouple the physical adjacency requirement from the yield constraint. Good reticles may be harvested from any location on one or more source wafers and repositioned on a carrier to form the desired array configuration. The optical couplers and optional optical bridges may provide the optical connectivity between the repositioned tiles that would otherwise be achieved through monolithic reticle stitching. This approach may enable the utilization of a higher percentage of functional reticles from each wafer, potentially approaching the full wafer yield rather than being limited by the availability of contiguous good reticle blocks.

Additionally, the techniques described herein may enable heterogeneous integration of tiles fabricated using different mask sets or processes. For example, tiles with v-grooves for fiber coupling may be positioned at the periphery of a reconstituted wafer, while tiles without v-grooves may be positioned in the interior. This flexibility may not be achievable with conventional monolithic reticle stitching, where all reticles on a wafer are typically fabricated using the same mask set. The ability to combine tiles of different types may expand the design space for wafer-scale photonic devices and may enable optimized configurations tailored to specific application requirements.

Die-to-die coupling may be achieved using different implementations, as described herein. One implementation involves an optical coupler disposed in a recess of the photonic tile, without an additional optical bridge. Light may be steered outside the plane of the waveguide using reflectors, and an index matching epoxy (IME) may be disposed between adjacent tiles to provide refractive index matching, thereby limiting reflections. Another implementation involves an optical bridge positioned on top of an optical coupler. A further implementation also involves an optical bridge and an optical coupler, but differs in that the optical coupler is mounted on the optical bridge.

In some embodiments, the tiles used in the reconstituted wafer may include identical photonic patterns formed from a common photomask set. Because each tile may represent the instantiation of a reticle shot, tiles fabricated on the same wafer or on different wafers using the same photomask set may have identical waveguide layouts, optical coupler interfaces, and photonic circuit patterns. Using tiles with identical photonic patterns may simplify the reconstitution process, as the optical couplers at the boundaries of any two adjacent tiles may be designed to align with each other regardless of which specific tiles are selected for reconstitution. In other embodiments, tiles fabricated using different photomask sets may be combined in a single reconstituted wafer.

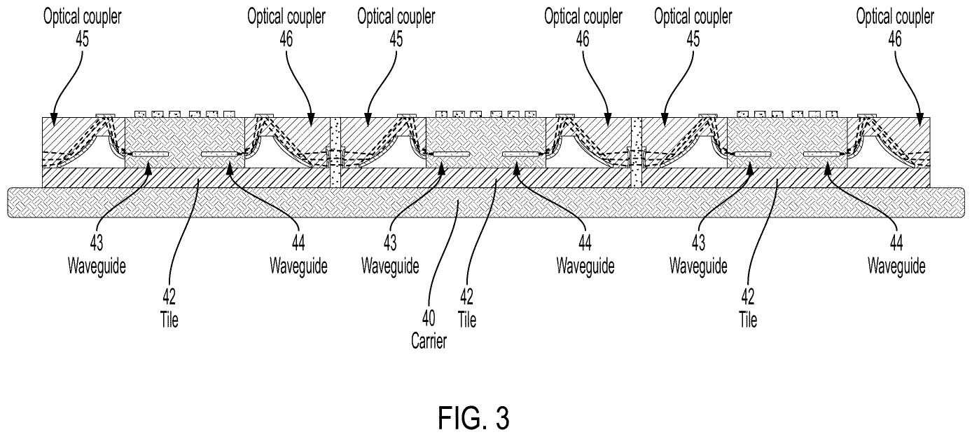

Referring to FIG. 3, a photonic integrated circuit assembly is shown that has been reconstituted on a carrier in accordance with the techniques described herein. FIG. 3 shows a cross-sectional view of a photonic integrated circuit assembly with multiple tiles 42 mounted on a carrier 40. Each tile 42 may include waveguides 43 and 44 that extend through the tile structure. Optical couplers 45 and 46 may be disposed in recesses formed in the tiles 42, with the optical couplers positioned at boundaries between adjacent tiles. The optical couplers 45 may be optically coupled to the waveguides 43, while the optical couplers 46 may be optically coupled to the waveguides 44. This arrangement may enable optical coupling between adjacent tiles 42 across the tile boundaries.

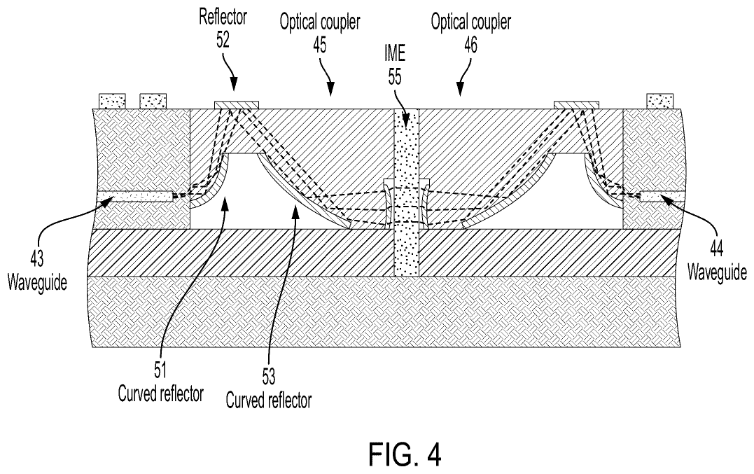

Referring to FIG. 4, a detailed view is shown of the internal components of an optical coupler arrangement between adjacent tiles. Waveguide 43 may be disposed on a first tile and waveguide 44 may be disposed on a second tile. Optical coupler 45 may be positioned adjacent to waveguide 43, and optical coupler 46 may be positioned adjacent to waveguide 44.

Within optical coupler 45, a curved reflector 51 may receive light from waveguide 43 and direct it toward reflector 52, steering the light outside the plane of waveguide 43. The curved geometry of reflector 51 may function to expand the mode field diameter of the light exiting waveguide 43 and collimate the beam, which may increase coupling efficiency and alignment tolerance between adjacent tiles. Reflector 52 may redirect the light, steering the optical signal toward the adjacent optical coupler 46. Optical coupler 46 may include a curved reflector 53 that receives the light transmitted from optical coupler 45 and directs it into waveguide 44. The curved reflectors 51 and 53 may function to expand the mode field diameter and collimate the beam, which may increase coupling efficiency and alignment tolerance between the adjacent tiles. An index matching epoxy 55 may be disposed between optical coupler 45 and optical coupler 46, occupying the gap between the two optical couplers and providing refractive index matching at the interface to limit reflections and reduce optical losses during signal transmission.

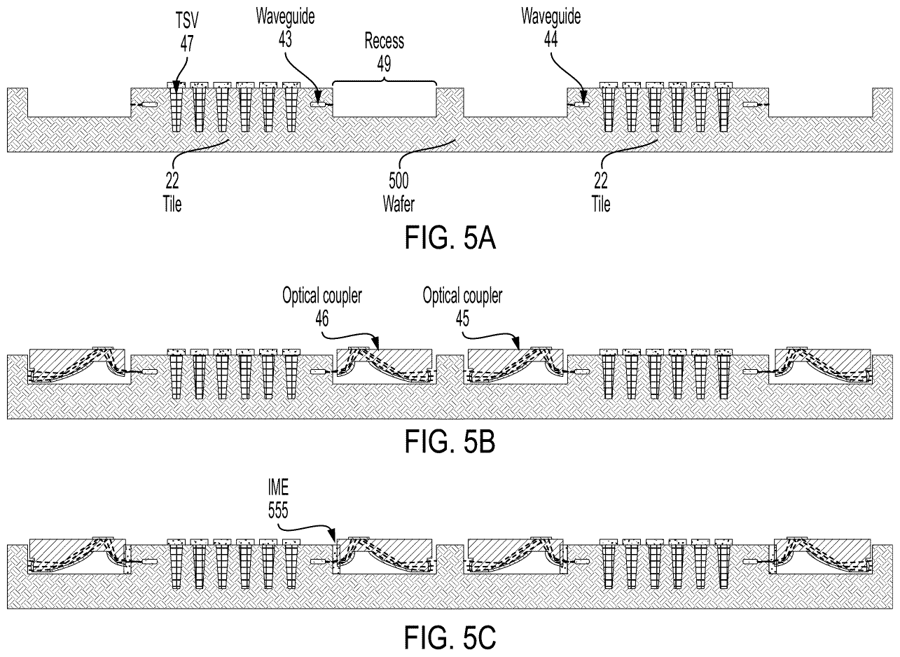

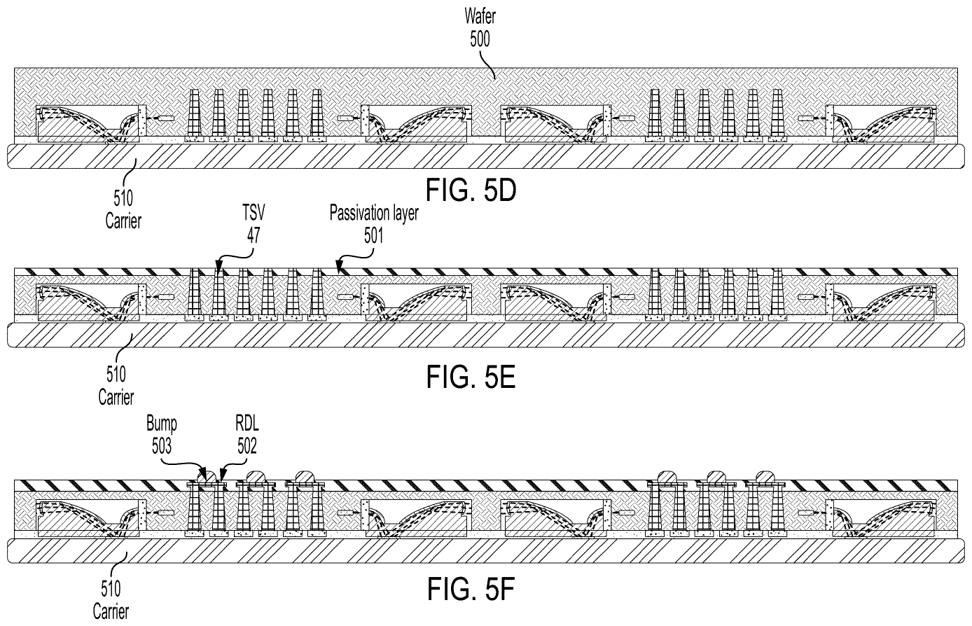

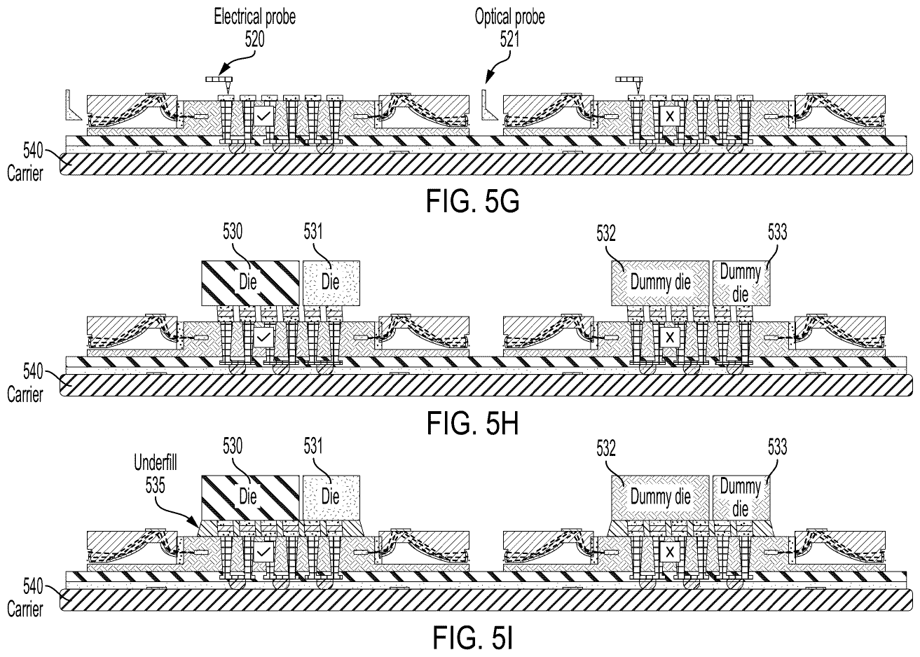

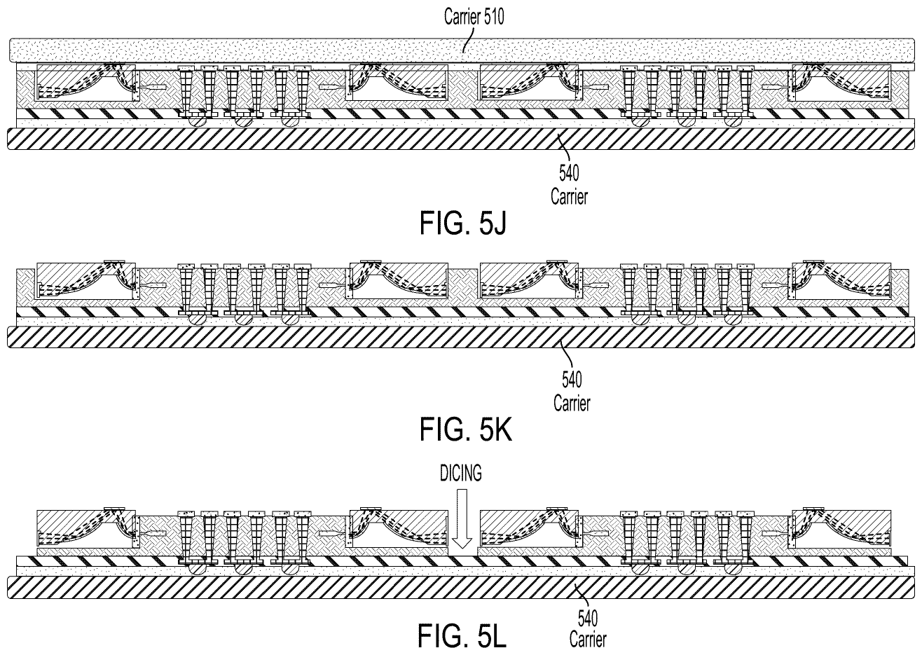

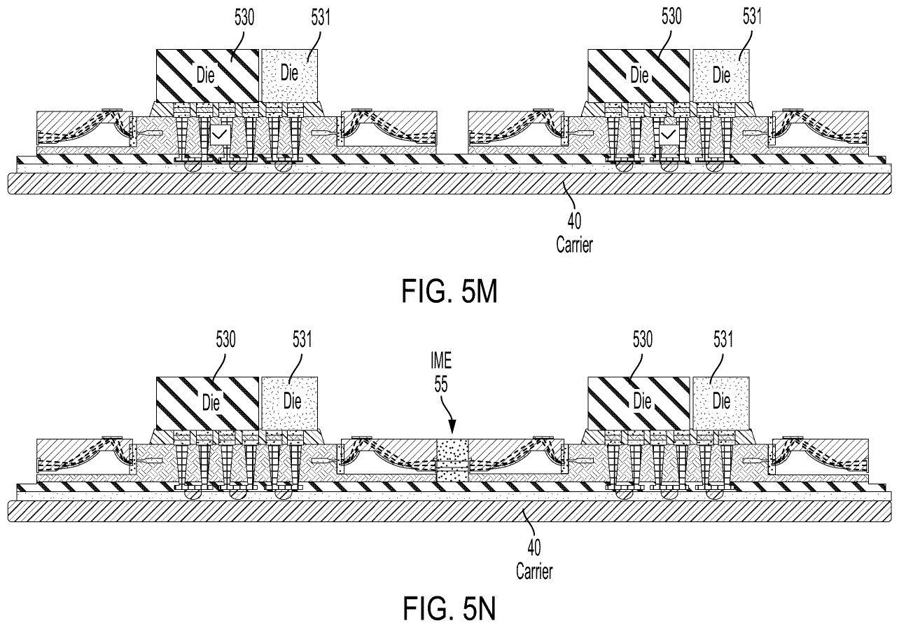

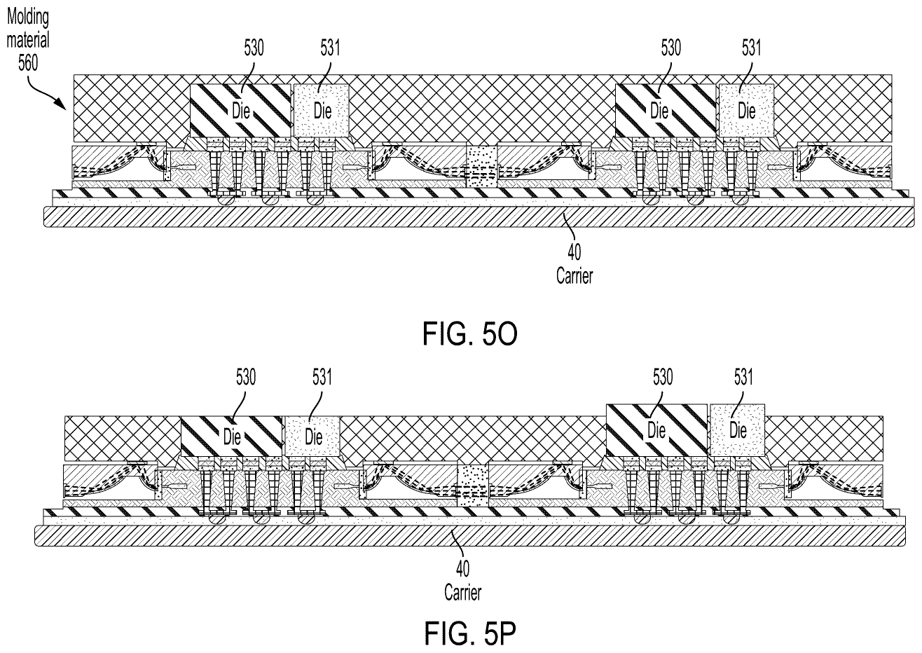

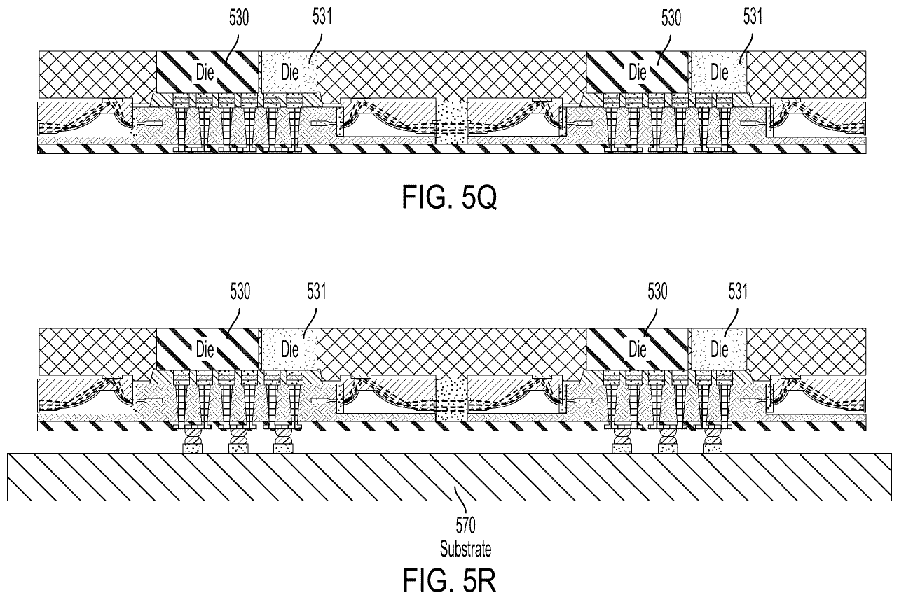

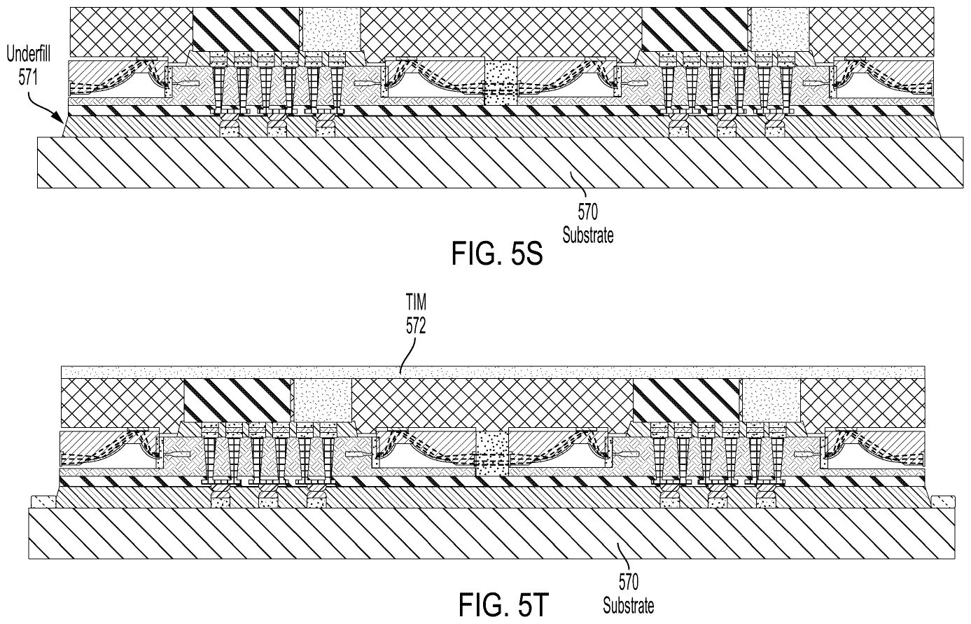

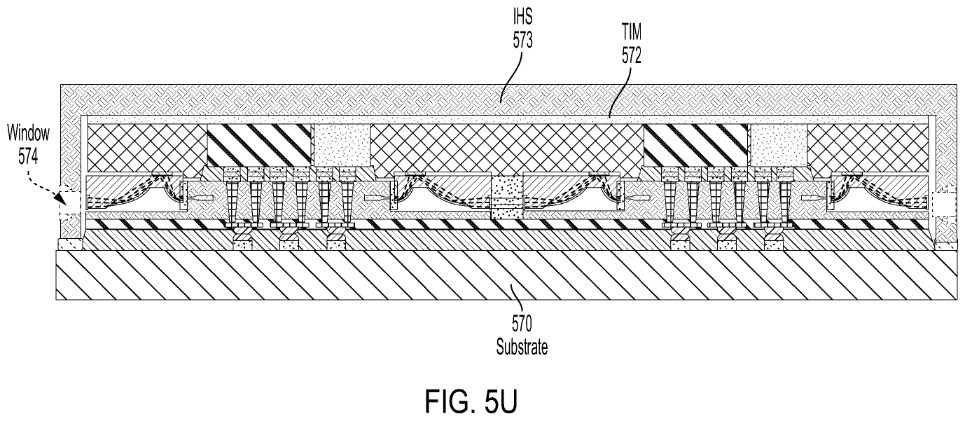

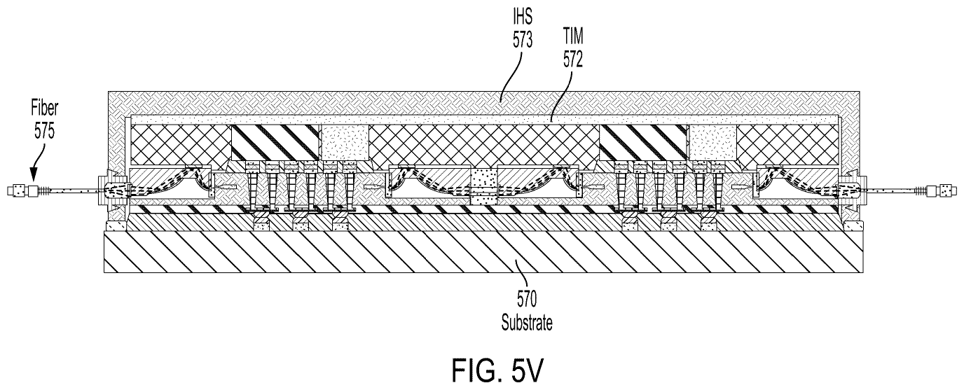

FIGS. 5A-5V illustrate a manufacturing process for fabricating a photonic integrated circuit with optical couplers enabling die-to-die communication. At a high level, the process begins with obtaining a wafer patterned with an array of photonic tiles, where optical couplers are mounted on the tiles to enable optical coupling between adjacent tiles. The tiles are then tested using electrical and optical probes to identify known good dies. Following testing, known good dies are extracted from one or more source wafers and reconstituted on a carrier to form a larger photonic integrated circuit, with index matching epoxy disposed between adjacent optical couplers to facilitate optical coupling across tile boundaries. The reconstituted assembly is then packaged with a substrate, thermal management components, and external optical connectivity.

Referring first to FIGS. 5A-5C, the optical coupler attachment process is illustrated. FIG. 5A shows an initial configuration where two tiles 22 are patterned on a wafer 500. Each tile 22 may include a waveguide 43 and a waveguide 44 extending within the tile structure. A through-silicon via (TSV) 47 may extend through each tile 22 to provide electrical connectivity in the vertical direction. Recesses 49 may be formed in the wafer 500 between adjacent tiles 22. FIG. 5B shows the configuration after optical couplers 45 and 46 have been mounted on the tiles 22, positioned within the respective tiles and configured to optically couple with the waveguides 43 and 44. The optical couplers 45 and 46 may face each other across the gap between the adjacent tiles 22. The optical couplers 45 and 46 may have been fabricated as part of a separate process from the tiles 22 and may be made of any suitable material that is transparent at the wavelength of interest. Examples of suitable materials include silicon and glass. FIG. 5C shows the configuration after an index-matching epoxy (IME) 555 has been dispensed and cured between the optical couplers 45 and 46, providing refractive index matching to reduce reflections and enable efficient die-to-die optical communication.

Referring to FIGS. 5D-5F, TSV reveal, RDL, and bumping operations are illustrated. In FIG. 5D, the wafer 500 may be mounted on a carrier 510, with TSVs 47 extending through the wafer 500. In FIG. 5E, a passivation layer 501 may be applied to the back side of the wafer 500 following a thinning process that reveals the TSVs 47. In FIG. 5F, a redistribution layer (RDL) 502 may be formed on the passivation layer 501, and bumps 503 may be deposited on the RDL 502 to enable electrical connectivity.

Referring to FIGS. 5G-5I, testing and die attachment operations are illustrated. FIG. 5G shows electrical probe 520 and optical probe 521 positioned above photonic tiles mounted on carrier 540 for testing. The electrical probe 520 may include needle probes, cantilever probes, or vertical probe cards configured to contact bond pads or test structures on the tiles to measure electrical characteristics. The optical probe 521 may include fiber-based probes, free-space optical probes with collimating optics, or grating coupler probes configured to couple light into and out of the waveguides within the tiles. Electrical testing may include measurements of resistance, capacitance, leakage current, continuity of through-silicon vias, and functionality of any electronic circuitry integrated with the photonic components. Optical testing may include measurements of waveguide insertion loss, optical coupling efficiency, spectral response, polarization characteristics, and functionality of optical components such as modulators, detectors, and multiplexers. The combination of electrical and optical testing may verify the integrity of both the electronic interconnects and the photonic circuitry within each tile. Based on the outcome of these tests and applicable acceptance criteria, each tile may be designated as a good die or a bad die. A checkmark in FIG. 5G indicates a tile that has passed the testing criteria and is designated as a good die, while an X indicates a tile that has failed one or more tests and is designated as a bad die.

FIG. 5H shows die 530 and die 531 mounted on tiles that passed testing, while dummy die 532 and dummy die 533 may be placed on tiles that failed testing. The dies 530 and 531 may be bonded to the tiles using flip-chip bonding techniques, where solder bumps or copper pillars on the dies are aligned with corresponding bond pads on the tiles and reflowed to form electrical and mechanical connections. The bonding process may involve thermocompression bonding, mass reflow, or other suitable attachment methods. The dies 530 and 531 may be processing chips, memory chips, routing chips, control chips, or other types of integrated circuits. In some embodiments, a die may include circuitry for controlling photonic devices, such as modulator drivers configured to provide electrical signals for driving optical modulators, and trans-impedance amplifiers configured to convert photocurrent from photodetectors into voltage signals. Additionally, or alternatively, a die may include serializer/deserializer (SerDes) circuitry configured to convert between parallel data streams and high-speed serial data streams for transmission over the optical interconnects.

The dummy dies 532 and 533 may be placed on failing tiles to maintain planarity across the assembly during subsequent processing steps, such as molding and planarization, even though these tiles will not be used in the final reconstituted circuit. FIG. 5I shows underfill 535 dispensed between the dies and the underlying structure.

Referring to FIGS. 5J-5L, carrier transfer and dicing operations are illustrated. In FIG. 5J, carrier 510 may be positioned above the assembly on carrier 540. The carrier transfer process may involve precise alignment of carrier 510 with the assembly to ensure proper contact and support during the transfer operation. The positioning may be achieved using automated pick-and-place equipment with vision systems to ensure accurate alignment of the carrier with the underlying assembly. FIG. 5K shows the assembly after carrier 510 has been removed, leaving the tiles mounted on carrier 540. The removal of carrier 510 may expose the upper surfaces of the die assemblies and may be performed using mechanical separation, thermal release, or laser debonding techniques depending on the adhesive or bonding method used to attach carrier 510. The successful removal may leave the tile assemblies with their optical couplers and interconnect structures intact and ready for subsequent processing steps.

FIG. 5L depicts a dicing operation being performed to separate individual die assemblies. The dicing process may be performed using a precision dicing saw with a diamond blade or laser dicing equipment to create clean, straight cuts through the wafer material. The dicing process may be performed while the assembly remains mounted on carrier 540 to provide mechanical support and prevent damage to the delicate structures. Following dicing, each separated tile assembly may include a photonic tile with its associated optical coupler, any mounted die, and the necessary interconnect structures such as TSVs and bumps. The individual tile assemblies may then be sorted based on their test results, with known good die assemblies selected for use in the wafer reconstitution process while failed assemblies may be discarded.

Referring to FIGS. 5M-5N, the known good die reconstruction process is illustrated. FIG. 5M represents a critical step in the wafer reconstitution process, where known good tile assemblies that have passed electrical and optical testing are selectively extracted from one or more source wafers and repositioned on carrier 40 to form a reconstituted photonic integrated circuit. This step enables the decoupling of the physical adjacency requirement from the yield constraint that limits conventional reticle stitching approaches. In FIG. 5M, two tile assemblies with die 530 and die 531 may be mounted on carrier 40. The tile assemblies may be positioned with precise alignment to ensure that the optical couplers at the tile boundaries are properly oriented for optical coupling. The positioning of the tile assemblies on carrier 40 may be achieved using automated pick-and-place equipment with vision systems that reference alignment fiducials on the tiles and the carrier. The spacing between adjacent tile assemblies may be controlled to accommodate the optical coupling requirements, with the gap between optical couplers sized to enable efficient free space optical propagation. Checkmarks in FIG. 5M indicate that only known good dies have been selected for reconstruction, with each tile assembly having passed the electrical and optical testing criteria. The reconstruction process shown in FIG. 5M may utilize tiles harvested from any location on the source wafers, regardless of whether adjacent tiles on the source wafers were functional, thereby enabling utilization of a higher percentage of functional tiles from each wafer compared to conventional monolithic reticle stitching. In FIG. 5N, index matching epoxy 55 may be dispensed between the adjacent tile assemblies to enable optical coupling between the waveguides of adjacent tiles.

Referring to FIG. 5O-5P, molding operations are illustrated. As shown in FIG. 5O, molding material 560 may be disposed around and between the die assemblies on carrier 40, encapsulating the upper portions of the assembly and providing structural support and protection. FIG. 5P illustrates a planarization step where the molding material 560 may be ground or polished to create a flat, uniform surface across the assembly. The planarization process may remove excess molding material and expose the upper surfaces of the dies 530 and 531, creating a co-planar surface that facilitates subsequent processing steps such as carrier transfer and substrate attachment.

Referring to FIGS. 5Q-5R, substrate attachment is illustrated. FIG. 5Q shows the reconstituted wafer assembly with die 530 and die 531 mounted on respective tiles, with optical couplers positioned at the tile boundaries and index matching epoxy disposed between adjacent optical couplers. FIG. 5R shows the assembly after attachment to substrate 570, which may provide mechanical support and electrical connectivity for the reconstituted wafer. The substrate 570 may be sized to accommodate a plurality of reconstituted tiles arranged in a matrix configuration. Given that each tile corresponds to a reticle having dimensions of approximately 26 mm×33 mm, for example, a substrate configured to support a 3×3 matrix of tiles may have dimensions of at least approximately 78 mm×99 mm, corresponding to a surface area of at least approximately 7,722 mm². A substrate configured to support a 4×2 matrix of tiles may have dimensions of at least approximately 104 mm×66 mm, corresponding to a surface area of at least approximately 6,864 mm². More generally, the substrate may have a surface area of at least approximately 6,000 mm², or at least approximately 7,000 mm², or at least approximately 8,000 mm². The substrate may be larger than the combined area of the tiles to accommodate spacing between tiles for optical couplers, index matching epoxy, and electrical routing.

Referring to FIGS. 5S-5T, underfill and thermal interface material (TIM) application are illustrated. FIG. 5S shows underfill 571 disposed between the photonic dies and the substrate 570, filling the gaps around the interconnect structures. FIG. 5T shows TIM 572 applied on top of the die complex to facilitate heat dissipation.

Referring to FIG. 5U, a completed package with IHS 573 attached is illustrated. The IHS 573 may include a window 574 formed at its periphery, which may provide optical access to the underlying photonic components for external optical coupling such as fiber attachment.

Referring to FIG. 5V, fiber attachment through the window opening is illustrated. A fiber 575 is attached at the edge of the assembly, coupling to an optical coupler through the window region of the IHS 573 for external optical signal input and output. A fiber array unit (FAU) may be used to hold the fiber 575 in place during attachment and operation. The FAU may comprise a substrate with precisely positioned v-grooves or other alignment features that maintain multiple optical fibers in a fixed spatial arrangement corresponding to the optical coupler positions on the photonic integrated circuit.

The manufacturing process illustrated in FIGS. 5A-5V represents an implementation that utilizes optical couplers to achieve die-to-die optical coupling between adjacent tiles. Other implementations described herein further include optical bridges that are mounted above or below the optical couplers to further improve reticle-to-reticle optical coupling. These optical bridges may provide additional optical elements such as reflectors and lenses that redirect and collimate light between the optical couplers of adjacent tiles, potentially offering enhanced coupling efficiency or different packaging configurations.

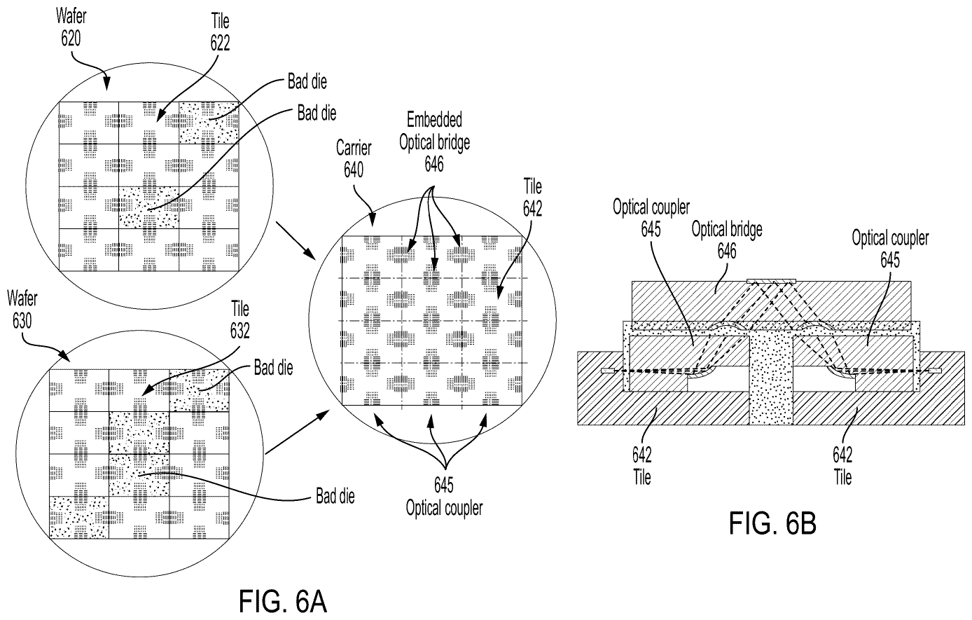

Referring to FIGS. 6A-6B, a wafer reconstitution process for forming a photonic device with embedded optical bridges is illustrated. Similar to the implementation of FIG. 3, good tiles (tile 622 from wafer 620 and tile 632 from wafer 630) may be extracted and transferred to carrier 640. The difference is that each tile 642 on carrier 640 may include an optical coupler 645 at the edges, and an embedded optical bridge 646 may be disposed between adjacent tiles to enable optical coupling across tile boundaries. FIG. 6B shows a cross-sectional view where the optical bridge 646 is positioned above and spans across two adjacent tiles 642, with each tile 642 including an optical coupler 645 that interfaces with the optical bridge 646.

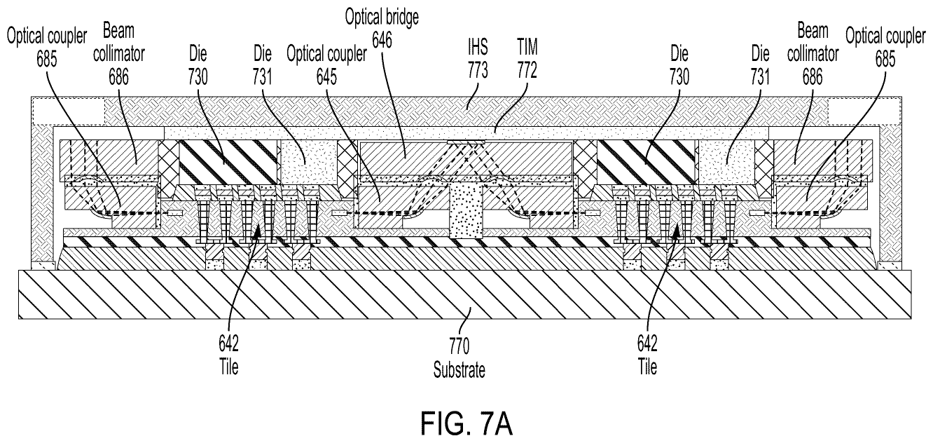

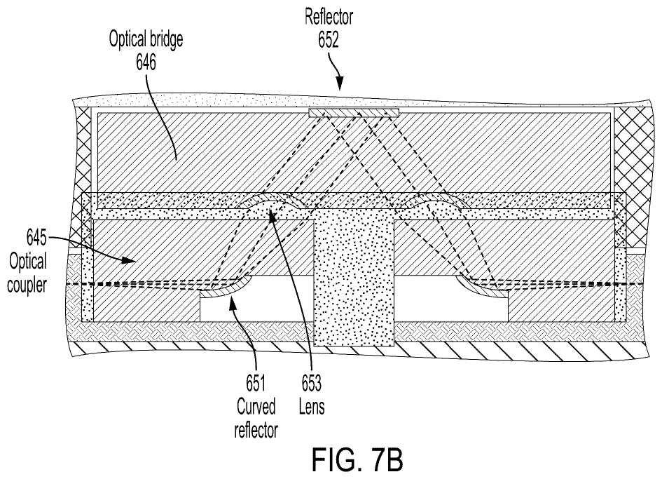

Referring to FIG. 7A, a cross-sectional view of a photonic package assembly including an optical bridge 646 is depicted. Two tiles 642 may be mounted on substrate 770, with each tile supporting die 730 and die 731. An optical coupler 645 may be positioned between adjacent tiles 642, and an optical bridge 646 may be disposed on top of the optical coupler 645, spanning the gap between the tiles 642. At the outer edges of the package, optical couplers 685 and beam collimators 686 may be positioned on the tiles 642 to facilitate external optical connections. TIM 772 may be disposed above the dies, and IHS 773 may be positioned above the TIM 772 to provide thermal management.

Referring to FIG. 7B, a detailed view of the optical coupling arrangement is depicted. The optical bridge 646 may be positioned above and span across two optical couplers 645, which may be disposed in respective tiles. A reflector 652 may be located at an upper surface of the optical bridge 646. A curved reflector 651 may be positioned within the optical couplers 645 to steer light outside the plane of waveguides within a tile. A lens 653 may extend vertically between the optical bridge 646 and the optical couplers 645. Light paths may extend from the curved reflectors 651 through the lens 653 and toward the reflector 652, demonstrating the optical coupling pathway between adjacent tiles via the optical bridge 646. The optical bridge 646 may improve coupling efficiency by collimating the incoming large mode field diameter beam from the optical coupler 645 of a transmitting tile and redirecting it toward the optical coupler 645 of an adjacent receiving tile. The expanded mode field diameter provided by the curved reflectors 651 and the collimation provided by the lens 653 may increase alignment tolerance during coupler-to-bridge attachment, thereby relaxing the precision requirements for tile positioning during wafer reconstitution. This arrangement may reduce optical losses at the tile boundaries compared to direct free space coupling between optical couplers without an intervening optical bridge.

In an alternative implementation, the optical couplers may be omitted and the optical bridge alone may be used to achieve die-to-die optical coupling. In this implementation, the tiles may be equipped with grating couplers to steer light outside of the plane of the waveguides. The grating couplers may direct light from the waveguides upward into the optical bridge, and may receive light from the optical bridge and couple it into the waveguides. The optical bridge may include reflectors and lenses configured to redirect and collimate light traveling between the grating couplers of adjacent tiles. This configuration may simplify the assembly process by eliminating the separate optical coupler components while still enabling efficient optical coupling across tile boundaries through the optical bridge.

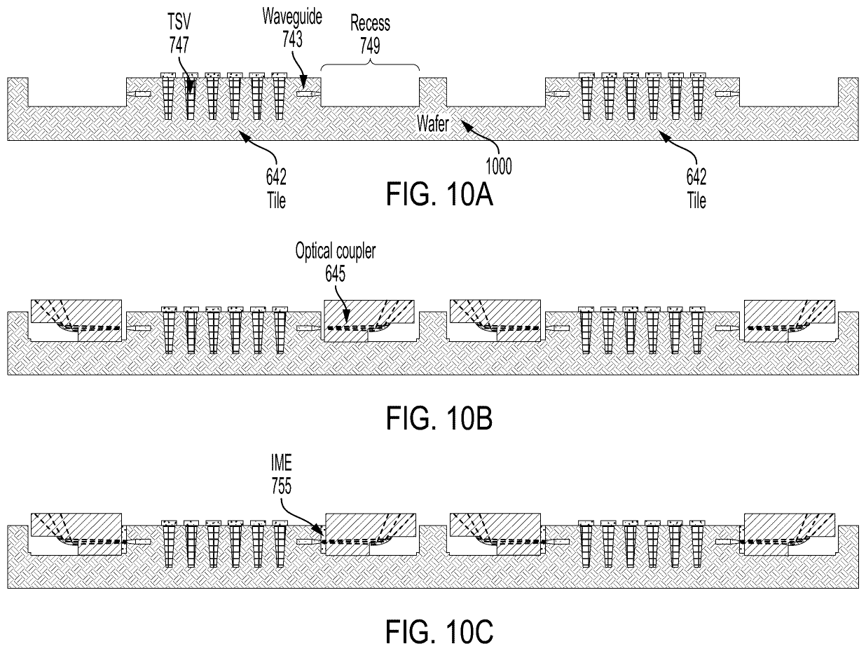

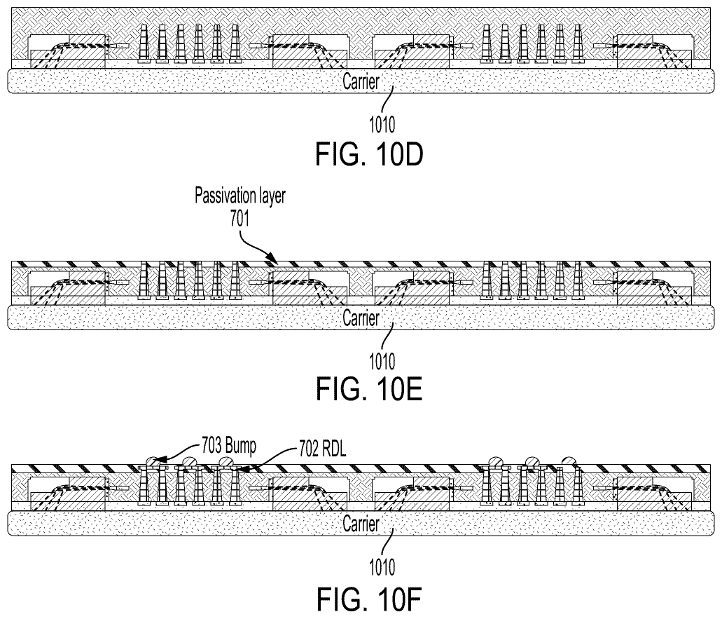

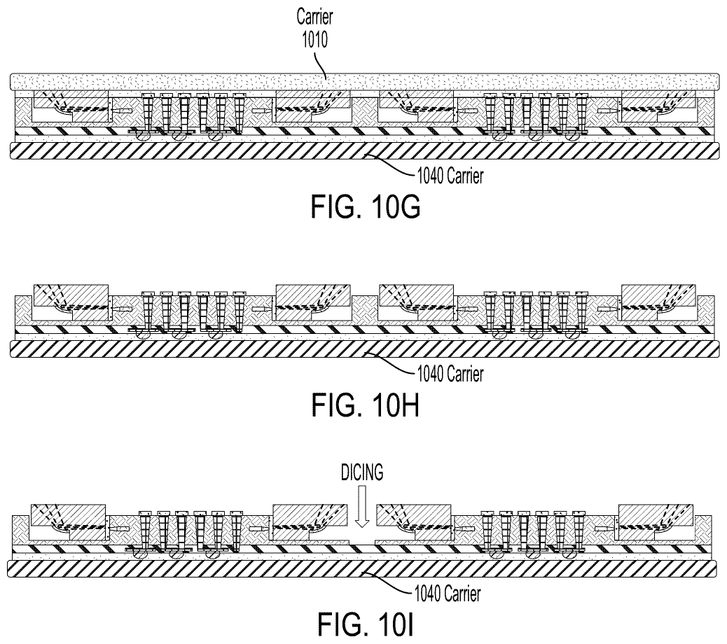

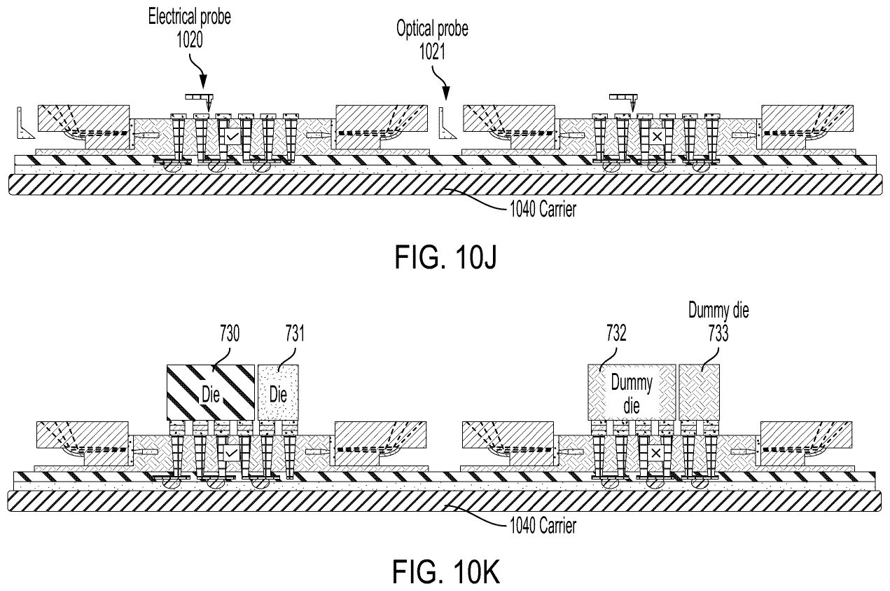

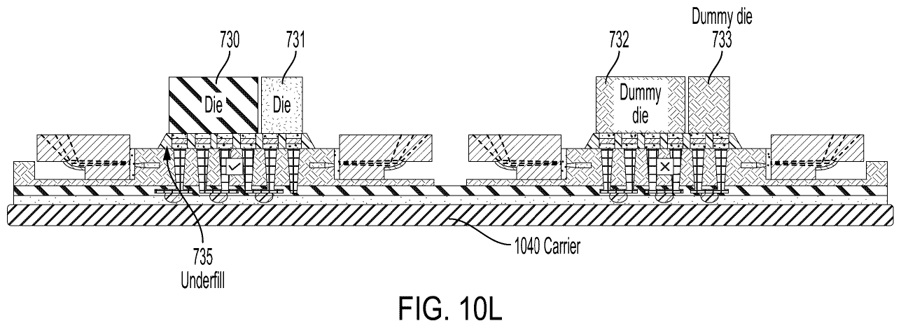

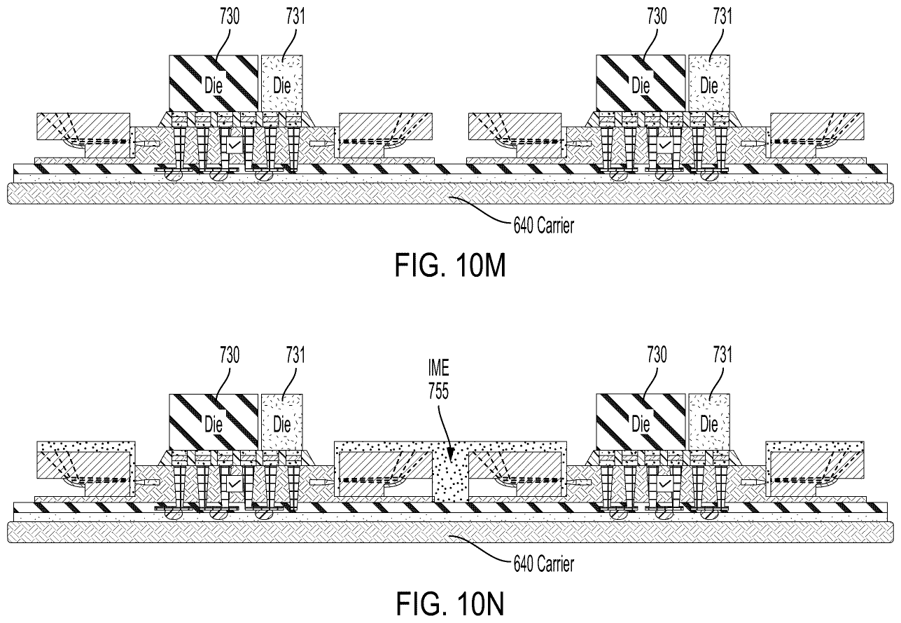

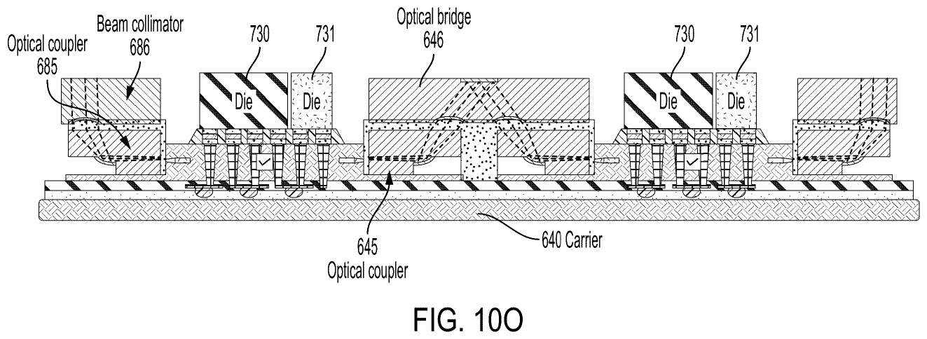

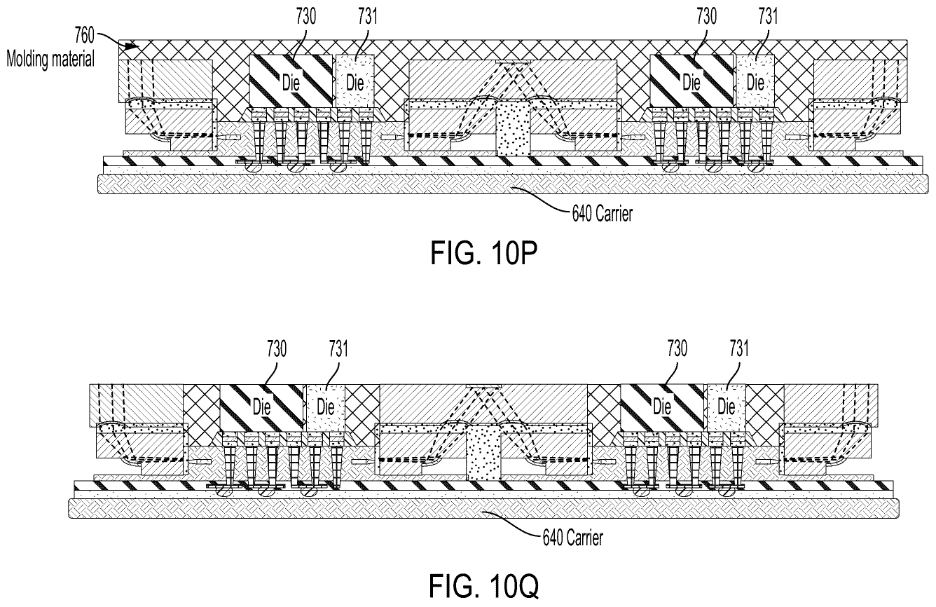

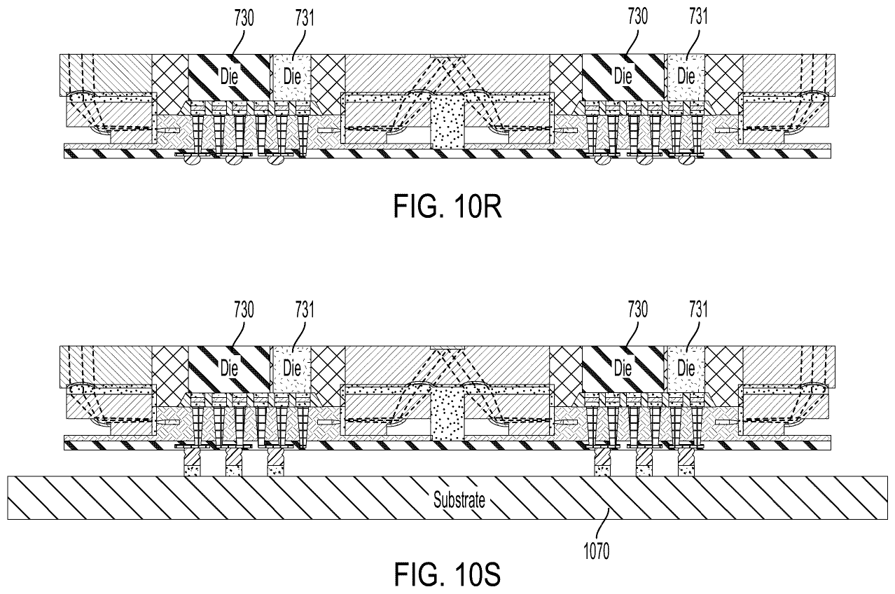

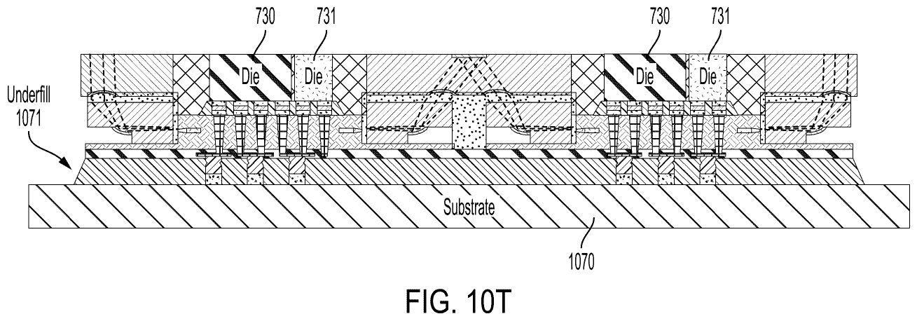

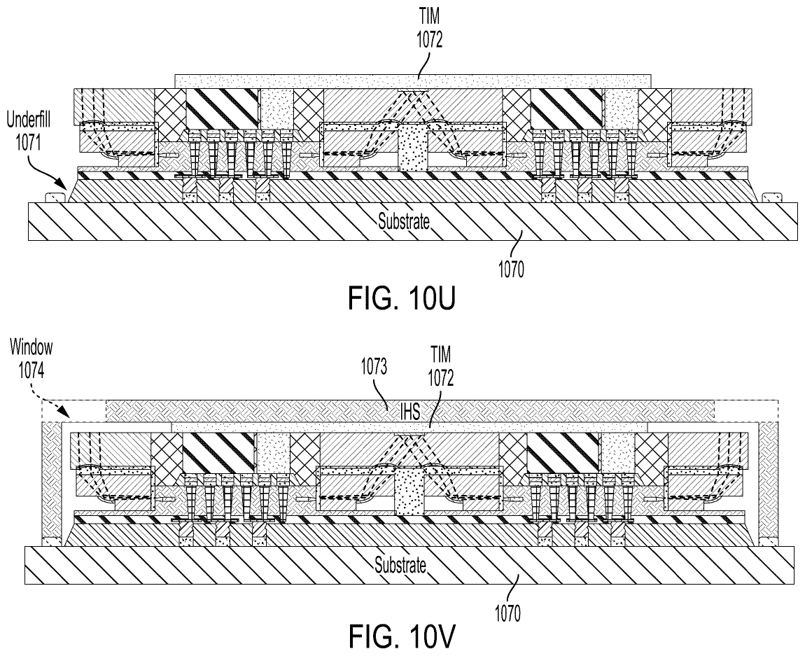

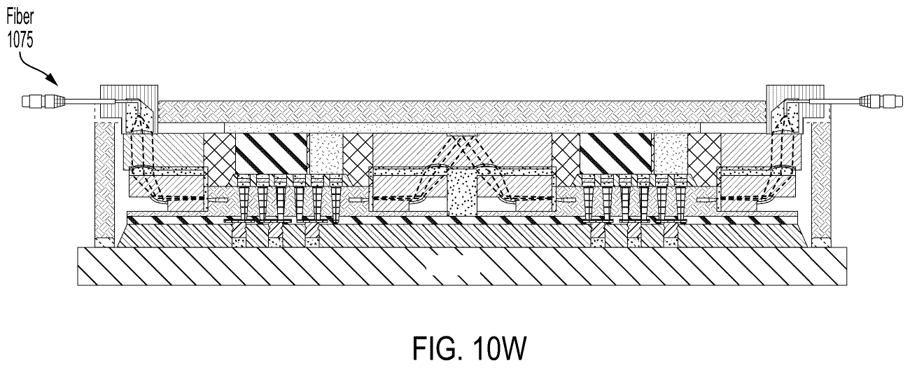

FIG. 10A-10W illustrate a manufacturing process for fabricating a photonic integrated circuit with optical bridges enabling die-to-die communication. Upon reconstruction, optical stitching between the adjacent reticles may occur through an optical bridge which may be embedded in the die complex during the chip-on-wafer process. The process shares several steps with the process shown in FIGS. 5A-5V, with differences noted below.

Referring first to FIGS. 10A-10C, the optical coupler attachment is illustrated, similar to FIGS. 5A-5C. In FIG. 10A, a wafer 1000 may include two tiles 642, each with a waveguide 743 and TSVs 747, with a recess 749 formed between adjacent tiles. FIG. 10B shows optical couplers 645 attached to each tile 642, positioned within recessed regions and configured to interface with the waveguides 743. FIG. 10C shows IME 755 dispensed and cured between the optical couplers 645 of adjacent tiles.

Referring to FIGS. 10D-10F, TSV reveal, RDL, and bumping operations are illustrated, similar to FIGS. 5D-5F. In FIG. 10D, carrier 1010 may support the tiles. In FIG. 10E, passivation layer 701 may be deposited. In FIG. 10F, RDL 702 and bumps 703 may be formed.

FIGS. 10G-10I illustrate carrier transfer and dicing operations, similar to FIGS. 5J-5L, using carriers 1010 and 1040. Referring to FIGS. 10J-10L, testing and die attachment are illustrated, similar to FIGS. 5G-5I. In FIG. 10J, electrical probe 1020 and optical probe 1021 may test the tiles on carrier 1040. In FIG. 10K, die 730 and die 731 may be mounted on passing tiles, while dummy die 732 and dummy die 733 may be placed on failing tiles. In FIG. 10L, underfill 735 may be applied.

Referring to FIGS. 10M-10O, the known good die reconstruction and optical bridge attachment are illustrated. In FIG. 10M, tile assemblies with die 730 and die 731 may be mounted on carrier 640. In FIG. 10N, IME 755 may be dispensed between adjacent tile assemblies.

In FIG. 10O, optical bridge 646 may be attached spanning across adjacent tiles, with optical couplers 685 and beam collimators 686 attached at the outer edges. This step represents a key difference from the manufacturing process illustrated in FIGS. 5A-5V. In the process of FIGS. 5A-5V, die-to-die optical coupling is achieved solely through the optical couplers disposed in the recesses of adjacent tiles, with index matching epoxy providing refractive index matching for free space optical propagation between the couplers. By contrast, the process of FIGS. 10A-10W incorporates the optical bridge 646 as an additional optical element that spans across adjacent tiles and provides reflectors and lenses to redirect and collimate light between the optical couplers 645 of neighboring tiles. The optical bridge 646 may improve coupling efficiency by collimating the incoming large mode field diameter beam from the optical coupler of a transmitting tile and redirecting it toward the optical coupler of an adjacent receiving tile. The beam collimators 686 and optical couplers 685 at the outer edges facilitate external optical connectivity for fiber attachment.

Referring to FIGS. 10P-10Q, molding operations are illustrated, similar to FIG. 5O-5P. Molding material 760 may encapsulate the die assemblies on carrier 640.

Referring to FIGS. 10R-10T, substrate attachment and underfill are illustrated. In FIG. 10R, the assembly is shown prior to substrate attachment. In FIG. 10S, the die complexes may be mounted onto substrate 1070. In FIG. 10T, underfill 1071 may be applied.

Referring to FIGS. 10U-10V, the completed package is illustrated. In FIG. 10U, TIM 1072 may be disposed on top of the die complexes. In FIG. 10V, IHS 1073 with window 1074 may be attached.

Referring to FIG. 10W, fiber 1075 is shown attached to the beam collimator, providing an external optical interface for the assembly.

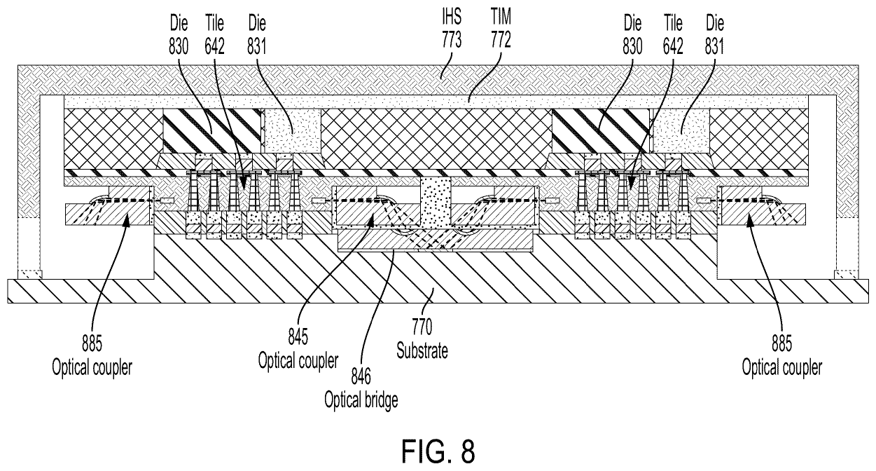

Referring to FIG. 8, a cross-sectional view similar to FIG. 7A is depicted, but with a key structural difference in the positioning of the optical bridge relative to the optical couplers. In FIG. 7A, the optical bridge 646 is positioned above the optical couplers 645, whereas in FIG. 8, the optical bridge 846 is positioned beneath the optical couplers 845. Tiles 642 may be mounted on substrate 770, each supporting a die 830 and a die 831.

As shown, an optical coupler 845 may be disposed between the tiles, and an optical bridge 846 may be positioned beneath the optical coupler 845 and embedded within the substrate 770 (rather than above the optical coupler as in the second implementation). Optical couplers 885 may be located at the outer edges for external connectivity. TIM 772 and IHS 773 may provide thermal management.

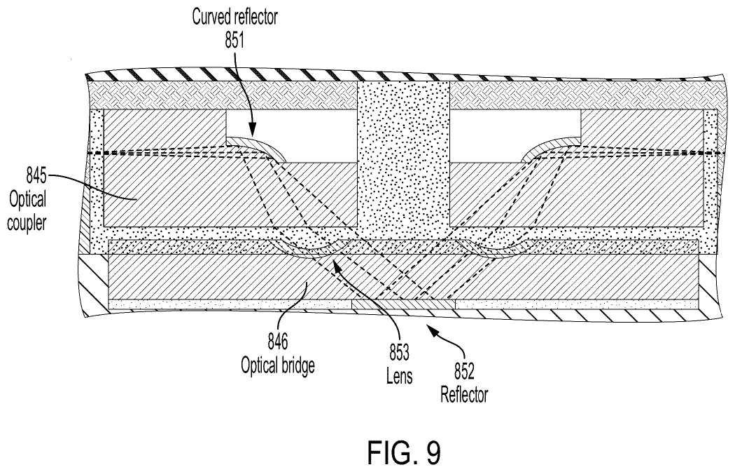

Referring to FIG. 9, a detailed view of this arrangement is depicted. The optical coupler 845 may be disposed within each tile, with one optical coupler 845 on the left side and another on the right side. An optical bridge 846 may be positioned below the optical couplers 845 and span the region between the two tiles. A curved reflector 851 may be located at an upper portion of the structure, positioned centrally between the two optical couplers 845. A reflector 852 may be disposed within the optical bridge 846 and may be configured to redirect light between the optical couplers 845. A lens 853 may be positioned within the optical bridge 846 adjacent to the reflector 852, configured to collimate or focus light traveling through the optical bridge 846.

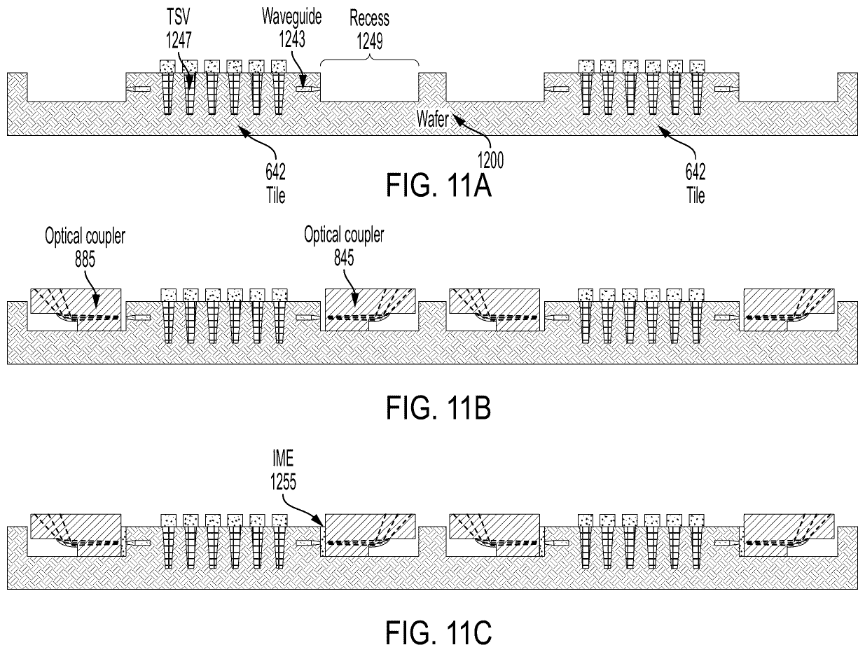

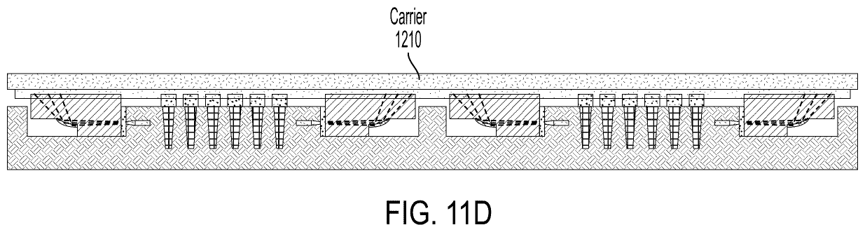

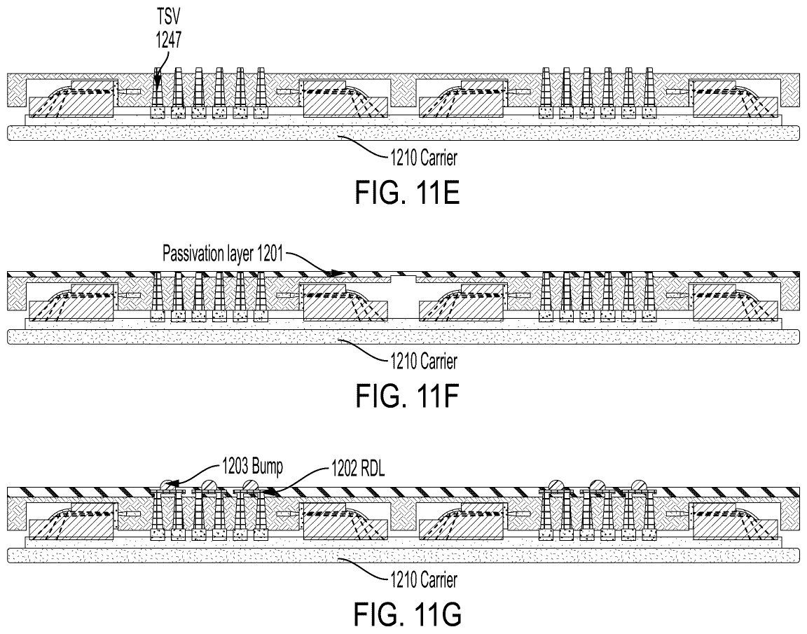

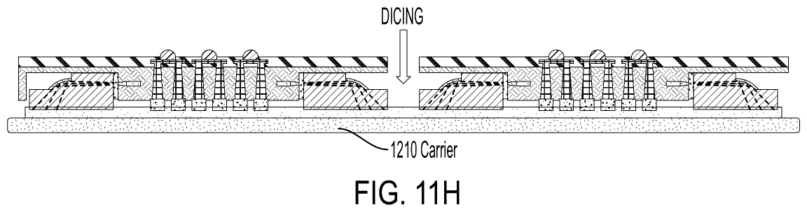

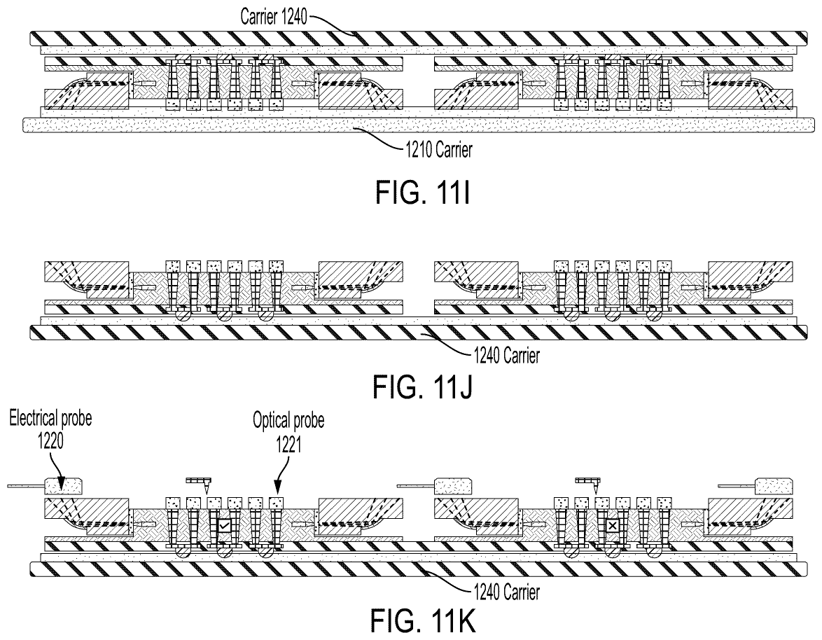

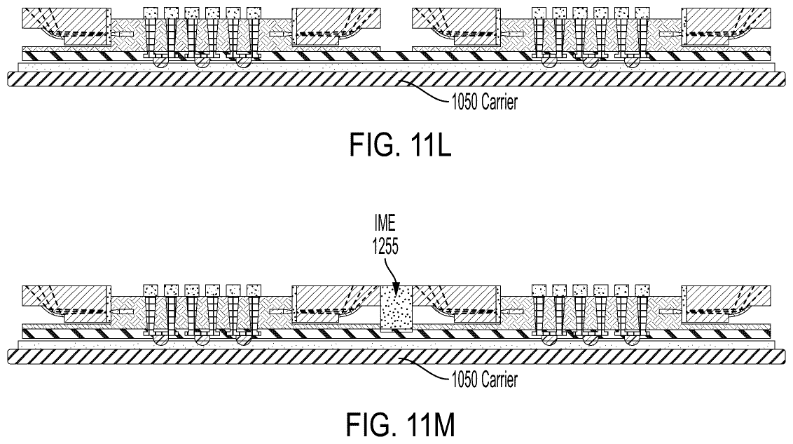

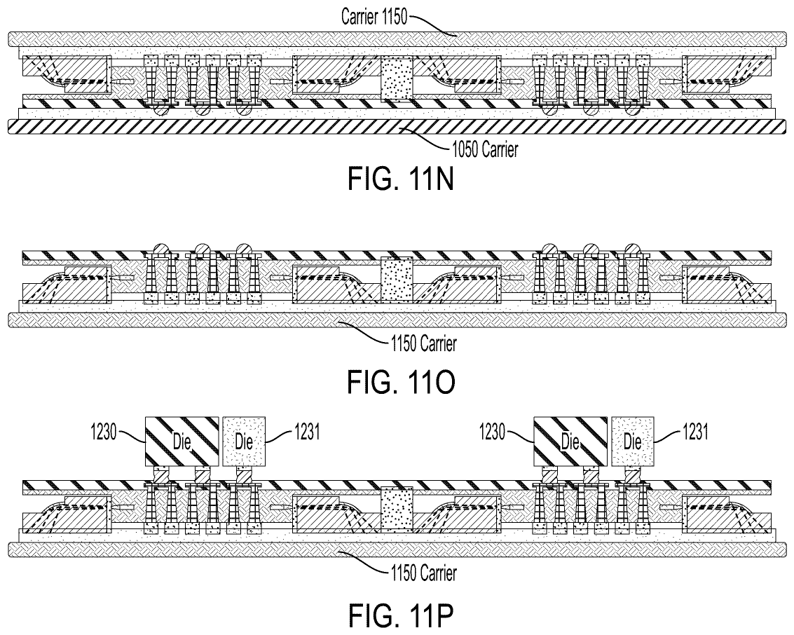

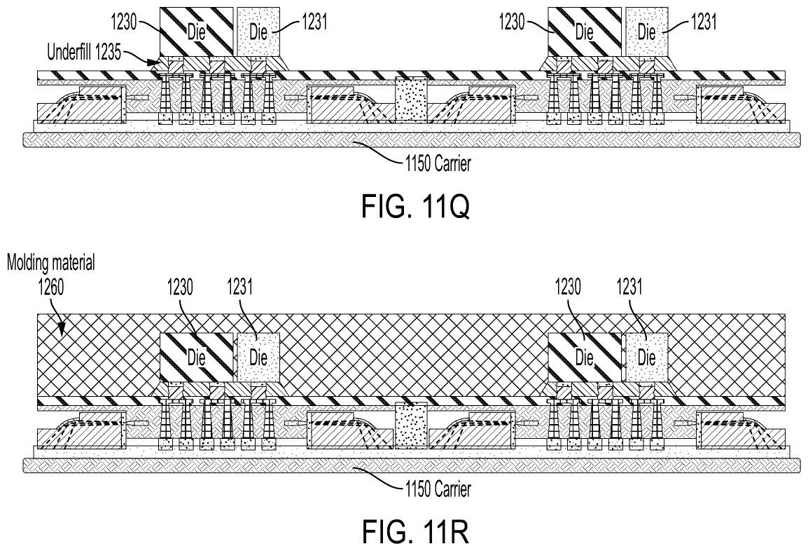

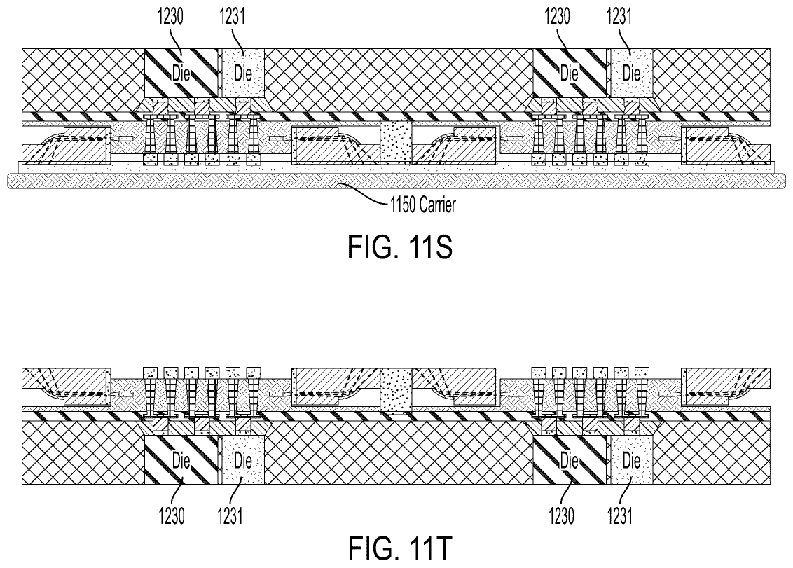

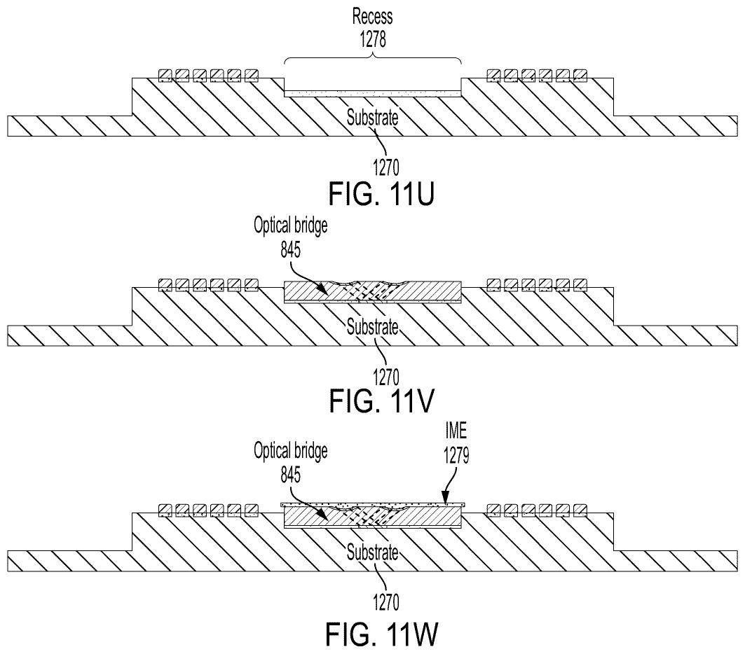

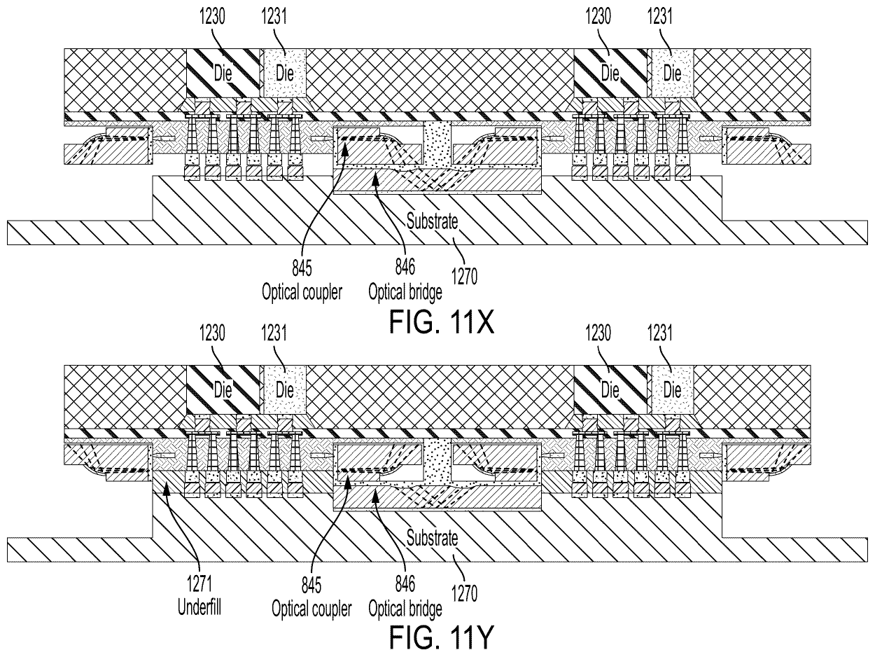

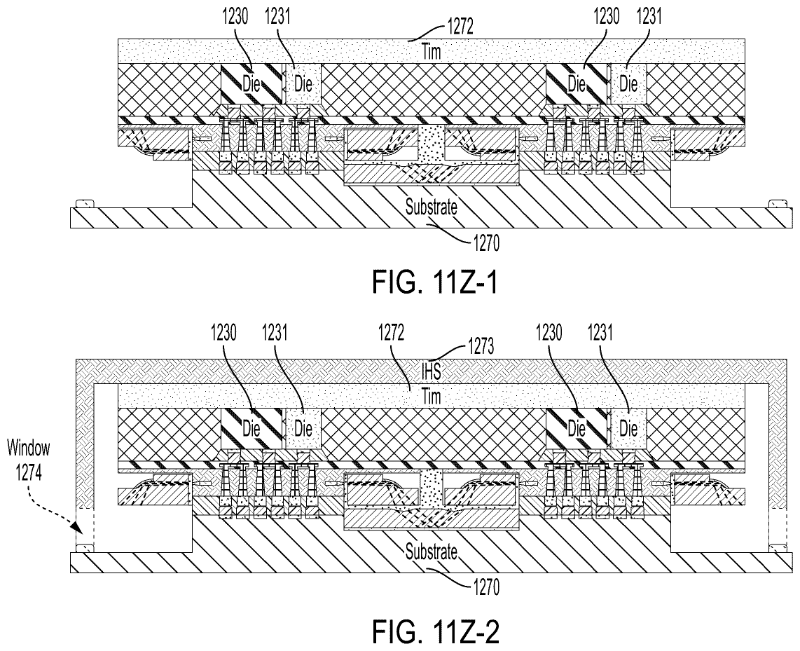

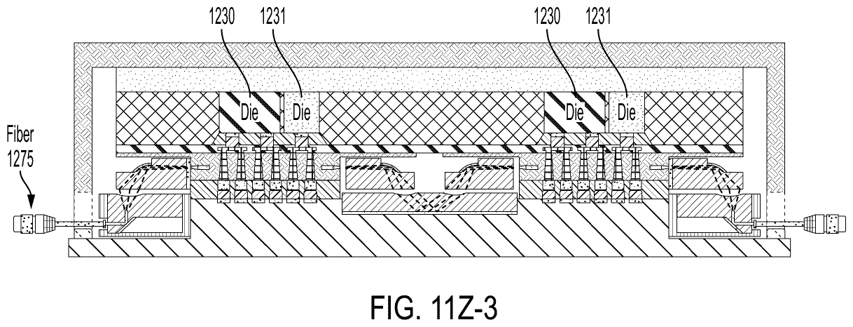

FIGS. 11A-11Z-3 illustrate a manufacturing process for fabricating a photonic integrated circuit with an optical bridge embedded in the substrate. During package assembly, this optical bridge may stitch optical signals between optical couplers of the adjacent dies. The process shares many steps with the previous implementations, with key differences noted below.

Referring to FIGS. 11A-11D, optical coupler attachment and carrier bonding are illustrated. In FIG. 11A, tiles 642 may be positioned on wafer 1200, each with TSVs 1247, waveguide 1243, and recess 1249. In FIG. 11B, optical coupler 885 and optical coupler 845 may be attached. In FIG. 11C, IME 1255 may be dispensed between adjacent optical couplers. In FIG. 11D, carrier 1210 may be attached.

Referring to FIGS. 11E-11H, TSV reveal, RDL, bumping, and dicing operations are illustrated. In FIG. 11E, tiles may be mounted on carrier 1210 with TSV 1247 structures. In FIG. 11F, passivation layer 1201 may be deposited. In FIG. 11G, RDL 1202 and bumps 1203 may be formed. FIG. 11H depicts a dicing operation.

Referring to FIGS. 11I-11K, carrier transfer and testing are illustrated. In FIG. 11I, tiles may be positioned between carrier 1240 and carrier 1210. In FIG. 11J, the assembly is shown with carrier 1240 at the bottom. In FIG. 11K, electrical probe 1220 and optical probe 1221 may test the tiles.

Referring to FIGS. 11L-11M, known good die reconstruction on carrier 1050 is illustrated, with IME 1255 dispensed between adjacent tiles.

Referring to FIGS. 11N-11P, carrier transfer and die attachment are illustrated. In FIG. 11N, carrier 1150 may be positioned at the top with carrier 1050 at the bottom. In FIG. 11O, the assembly may be inverted with carrier 1150 at the bottom and carrier 1050 removed. In FIG. 11P, die 1230 and die 1231 may be attached.

Referring to FIGS. 11Q-11R, underfill and molding are illustrated. In FIG. 11Q, underfill 1235 may be applied. In FIG. 11R, molding material 1260 may encapsulate the assembly on carrier 1150.

Referring to FIGS. 11S-11T, carrier removal and assembly inversion are illustrated. In FIG. 11S, dies 1230 and 1231 may be positioned on carrier 1150. In FIG. 11T, the assembly is shown in an inverted orientation with carrier 1150 removed.

Referring to FIGS. 11U-11W, the optical bridge embedding in the substrate is illustrated. This represents a key difference from the manufacturing process illustrated in FIGS. 10A-10W. In the process of FIGS. 10A-10W, the optical bridge 646 is attached to the tile assemblies after the tiles have been reconstituted on the carrier, with the optical bridge positioned above the optical couplers. By contrast, in the process of FIGS. 11A-11Z-3, the optical bridge is embedded within the substrate prior to attachment of the die assemblies to the substrate. This approach positions the optical bridge beneath the optical couplers rather than above them, as shown in FIG. 8. In FIG. 11U, substrate 1270 may include a recess 1278 formed therein to accommodate the optical bridge. In FIG. 11V, optical bridge 846 may be placed within the recess 1278, positioning the optical bridge within the substrate structure before the die assemblies are attached. In FIG. 11W, IME 1279 may be dispensed over the optical bridge 846 to provide refractive index matching and facilitate optical coupling between the optical bridge and the optical couplers of the die assemblies that will be subsequently attached.

Referring to FIGS. 11X-11Y, substrate attachment is illustrated. The die assemblies may be attached to the substrate 1270 with the optical bridge 846 already in place within the recess 1278. This approach differs from the process of FIGS. 10A-10W, where the optical bridge is attached to the tile assemblies after reconstitution. By pre-embedding the optical bridge 846 in the substrate 1270, the substrate attachment step simultaneously establishes the optical coupling pathway between adjacent tiles, as the optical couplers 845 of the die assemblies align with the optical bridge 846 during the attachment process.

In FIG. 11X, die 1230 and die 1231 may be positioned on substrate 1270, with optical coupler 845 and optical bridge 846 positioned to enable die-to-die optical communication. In FIG. 11Y, underfill 1271 may be applied. Referring to FIGS. 11Z-1 and 11Z-2, the completed package is illustrated. TIM 1272 may be applied, and IHS 1273 with window 1274 may be attached. Referring to FIG. 11Z-3, fiber 1275 is shown connected for external optical connectivity.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

As used herein, terms such as “above,” “below,” “over,” “under,” “adjacent,” “upper,” “top,” “lower,” “bottom,” “vertical,” “horizontal,” “lateral,” and similar positional or directional descriptors are used solely to describe the relative arrangement and orientation of features as illustrated in the drawings and are not intended to be limiting. Such terms do not require any particular orientation of the device in use, manufacture, or operation, and the described features may be oriented in any direction without departing from the scope of the present disclosure. Moreover, these terms are not intended to imply any absolute position, gravitational reference, or fixed spatial relationship, and components described as being positioned using positional or directional descriptors may be arranged in different relative positions, including inverted, rotated, or otherwise reoriented configurations, while still performing the same function in substantially the same way to achieve substantially the same result.

What is claimed is:

1. A photonic device, comprising:
a substrate;
a first photonic tile, mounted on the substrate, comprising a first waveguide;
a second photonic tile, mounted on the substrate, comprising a second waveguide; and
a first optical coupler mounted on the first photonic tile and a second optical coupler mounted on the second photonic tile, wherein the first optical coupler is optically coupled to the first waveguide and the second optical coupler is optically coupled to the second waveguide, and wherein the first optical coupler is optically coupled to the second optical coupler.

2. The photonic device of claim 1, wherein the first optical coupler comprises a reflector configured to steer light outside a plane of the first waveguide.

3. The photonic device of claim 1, wherein the first optical coupler is disposed in a recess formed in the first photonic tile.

4. The photonic device of claim 1, further comprising an index matching epoxy disposed between the first optical coupler and the second optical coupler.

5. The photonic device of claim 1, wherein the first optical coupler comprises a curved reflector configured to expand a mode field diameter of light propagating from the first waveguide.

6. The photonic device of claim 1, further comprising an optical bridge optically coupling the first optical coupler to the second optical coupler.

7. The photonic device of claim 6, wherein the optical bridge is disposed on top of the first optical coupler and the second optical coupler, and wherein the optical bridge comprises a reflector.

8. The photonic device of claim 6, wherein the optical bridge is disposed in a recess formed in the substrate.

9. The photonic device of claim 8, wherein the optical bridge is between the recess formed in the substrate and the first optical coupler.

10. The photonic device of claim 1, wherein the first photonic tile and the second photonic tile comprise identical photonic patterns formed from a common photomask set.

11. A method of manufacturing a photonic device, the method comprising:
mounting a first optical coupler on a first photonic tile obtained from a first wafer, the first photonic tile comprising a first waveguide;
mounting a second optical coupler on a second photonic tile obtained from a second wafer, the second photonic tile comprising a second waveguide;
mounting the first photonic tile, with the first optical coupler mounted thereon, on a carrier; and
mounting the second photonic tile, with the second optical coupler mounted thereon, on the carrier such that the first waveguide is optically coupled to the second waveguide via the first optical coupler and the second optical coupler.

12. The method of claim 11, wherein the first optical coupler comprises a reflector configured to steer light outside a plane of the first waveguide.

13. The method of claim 11, wherein mounting the first optical coupler on the first photonic tile comprises disposing the first optical coupler in a recess formed in the first photonic tile.

14. The method of claim 11, further comprising dispensing an index matching epoxy between the first optical coupler and the second optical coupler.

15. The method of claim 11, further comprising:
testing the first photonic tile prior to mounting the first photonic tile on the carrier; and
selecting the first photonic tile for mounting on the carrier based on the testing.

16. The method of claim 11, further comprising mounting an optical bridge spanning the first optical coupler and the second optical coupler.

17. A method of manufacturing a photonic device, the method comprising:
obtaining a first wafer having a first plurality of photonic tiles;
mounting a first plurality of optical couplers on respective tiles of the first plurality of photonic tiles;
testing the first wafer to identify a first set of good dies from the first plurality of photonic tiles;
obtaining a second wafer having a second plurality of photonic tiles;
mounting a second plurality of optical couplers on respective tiles of the second plurality of photonic tiles;
testing the second wafer to identify a second set of good dies from the second plurality of photonic tiles; and
mounting at least some of the good dies of the first set and at least some of the good dies of the second set on a substrate such that at least one optical coupler of the first plurality of optical couplers is optically coupled to at least one optical coupler of the second plurality of optical couplers.

18. The method of claim 17, wherein at least one optical coupler of the first plurality comprises a reflector configured to steer light outside a plane of a waveguide of a respective tile of the first plurality of photonic tiles.

19. The method of claim 17, further comprising dispensing an index matching epoxy between the at least one optical coupler of the first plurality and the at least one optical coupler of the second plurality.

20. The method of claim 17, further comprising embedding an optical bridge in a recess formed in the substrate prior to mounting the good dies on the substrate, wherein the optical bridge is optically coupled to the at least one optical coupler of the first plurality and the at least one optical coupler of the second plurality.
